(19) United States
(12) Patent Application Publication
(10) Pub. No.: US 2019/0138350 A1
(43) Pub. Date: May 9, 2019

(54) INFORMATION PROCESSING APPARATUS AND INFORMATION PROCESSING SYSTEM

(71) Applicant: FUJITSU LIMITED, Kawasaki-shi (JP)

(72) Inventors: Takuma Kaneko, Kawasaki (JP); KENICHIROU SHIMOGAWA, Numazu (JP)

(73) Assignee: FUJITSU LIMITED, Kawasaki-shi (JP)

(21) Appl. No.: 16/168,893

(22) Filed: Oct. 24, 2018

(30) Foreign Application Priority Data
Nov. 7, 2017 (JP) 2017-214797

(51) Int. Cl. G06F 9/48; G06F 9/50; G06F 9/455; H04L 29/08; G06F 11/14

(52) U.S. Cl. CPC G06F 9/4856; G06F 9/4818; G06F 9/5038; G06F 2201/815; H04L 67/101; G06F 11/1484; G06F 2009/4557; G06F 9/45558

(57) ABSTRACT

An information processing apparatus includes a memory and a processor coupled to the memory. The processor is configured to acquire a data transfer rate between a source device and each of destination candidate devices. The information processing apparatus is communicably coupled to the source device and to the destination candidate devices. The source device serves as a migration source from which virtual machines are migrated. The destination candidate devices are candidates of a destination device serving as a migration destination to which each of the virtual machines is migrated. The processor is configured to determine, based on the acquired data transfer rate, the destination device for each of the virtual machines among the destination candidate devices in an order of priority set for each of the virtual machines.

### CROSS-REFERENCE TO RELATED APPLICATION

This application is based upon and claims the benefit of priority of the prior Japanese Patent Application 2017-214797, filed on Nov. 7, 2017, the entire contents of which are incorporated herein by reference.

### FIELD

The embodiments discussed herein are related to an information processing apparatus and an information processing system.

### BACKGROUND

As a function to secure the redundancy of a virtual server, there is a function called auto-failover. When an abnormality or the like occurs in a physical machine, the auto-failover secures the redundancy of a virtual machine (VM) operating on the physical machine by moving the VM to a separate physical machine of a normal state and restarting the VM. The term “physical machine” may be referred to as a “VM host”. The VM is recovered by copying the contents of the disk from a migration source VM host to a migration destination VM host, and restarting the VM.

As for a selection logic of the migration destination VM host, for example, there exists a load distribution type, a stuffing type, and a round robin. In the load distribution type, the VM host having the largest empty space is selected as a migration destination VM host. In the stuffing type, a VM host with the smallest empty space is selected as a migration destination VM host. In the round robin, plural VM hosts are sequentially selected as migration destination VM hosts.

When a restoration priority is set for each VM of a failed physical machine subordinate, a migration is sequentially performed in an order from a VM with the highest restoration priority to a migration destination VM host. That is, when an abnormality occurs in a VM host, the auto-failover is performed by checking the restoration priority of each VM of a subordinate of the VM host in which the abnormality has occurred and starting a migration in an order from a VM with the higher restoration priority.

Related techniques are disclosed in, for example, Japanese Laid-Open Patent Publication Nos. 2010-244524 and 2013-239095.

### SUMMARY

According to an aspect of the present invention, provide is an information processing apparatus including a memory and a processor coupled to the memory. The processor is configured to acquire a data transfer rate between a source device and each of destination candidate devices. The information processing apparatus is communicably coupled to the source device and to the destination candidate devices. The source device serves as a migration source from which virtual machines are migrated. The destination candidate devices are candidates of a destination device serving as a migration destination to which each of the virtual machines is migrated. The processor is configured to determine, based on the acquired data transfer rate, the destination device for each of the virtual machines among the destination candidate devices in an order of priority set for each of the virtual machines.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view for explaining an example of a VM deployment process as a related example;

FIG. 2 is a view for explaining an example of a VM migration process as a related example;

FIG. 3 is a view for explaining an example of a VM migration process as a related example;

FIG. 4 is a view for explaining an example of a VM migration process as a related example;

FIG. 5 is a view for explaining an example of a VM migration process as a related example;

FIG. 6 is a view illustrating a configuration example of an information processing system as an example of an embodiment;

FIG. 7 is a view illustrating an example of a VM migration process in the information processing system illustrated in FIG. 6;

FIG. 8 is a view illustrating a hardware configuration example of a management server and a VM host illustrated in FIG. 6;

FIG. 9 is a view illustrating a functional configuration example of the management server and the VM host illustrated in FIG. 6;

FIG. 10 is a view illustrating an example of a priority table used in the information processing system illustrated in FIG. 6;

FIG. 11 is a view for explaining an example of a VM migration process in the information processing system illustrated in FIG. 6;

FIG. 12 is a view for explaining an example of a VM migration process in the information processing system illustrated in FIG. 6;

FIG. 13 is a view for explaining an example of a VM migration process in the information processing system illustrated in FIG. 6;

FIG. 14 is a view for explaining an example of a VM migration process in the information processing system illustrated in FIG. 6;

FIG. 15 is a view for explaining an example of a transfer rate measurement process between two VM hosts in the information processing system illustrated in FIG. 6;

FIG. 16 is a view for explaining an example of a transfer rate measurement process between an even number of VM hosts in the information processing system illustrated in FIG. 6;

FIG. 17 is a view for explaining an example of a transfer rate measurement process between an even number of VM hosts in the information processing system illustrated in FIG. 6;

FIG. 18 is a view for explaining an example of a transfer rate measurement process between an even number of VM hosts in the information processing system illustrated in FIG. 6;

FIG. 19 is a view for explaining an example of a transfer rate measurement process between an odd number of VM hosts in the information processing system illustrated in FIG. 6;

FIG. 20 is a view for explaining an example of a transfer rate measurement process between an odd number of VM hosts in the information processing system illustrated in FIG. 6;

FIG. 21 is a flowchart for explaining an example of the VM migration process illustrated in FIGS. 11 to 14;

FIG. 22 is a flowchart for explaining an example of the transfer rate measurement process illustrated in FIGS. 15 to 20;

FIG. 23 is a view for explaining an example of a VM migration process in an information processing system as a modified example of the embodiment;

FIG. 24 is a view for explaining an example of a VM migration process in an information processing system as a modified example of the embodiment;

FIG. 25 is a view for explaining an example of a VM migration process in an information processing system as a modified example of the embodiment;

FIG. 26 is a view for explaining an example of a VM migration process in an information processing system as a modified example of the embodiment;

FIG. 27 is a view for explaining an example of a VM migration process in an information processing system as a modified example of the embodiment;

FIG. 28 is a view for explaining an example of a VM migration process in an information processing system as a modified example of the embodiment;

FIG. 29 is a view for explaining an example of a VM migration process in an information processing system as a related example;

FIG. 30 is a view for explaining an example of a VM migration process in an information processing system as a related example; and

FIG. 31 is a view for explaining an example of a VM migration process in an information processing system as a related example.

### DESCRIPTION OF EMBODIMENTS

In the auto-failover described above, although the migration is started in an order from the VM with the highest restoration priority, the time required for data transfer between the VM hosts is not taken into consideration and it may be delayed to complete the restoration of the VM with relatively higher restoration priority.

An embodiment will now be described with reference to the accompanying drawings. However, the following embodiment is merely an example and is not intended to exclude the application of various modifications and techniques not explicitly described in the embodiment. That is, the present embodiment may be implemented with various modifications without departing from the spirit and scope of the present disclosure.

Further, each figure is not intended to include only the constituent elements illustrated in the figure but may include other functions and the like.

Throughout the drawings, the same portions are denoted by the same reference numerals and explanation thereof will not be repeated.

### [A] Related Example

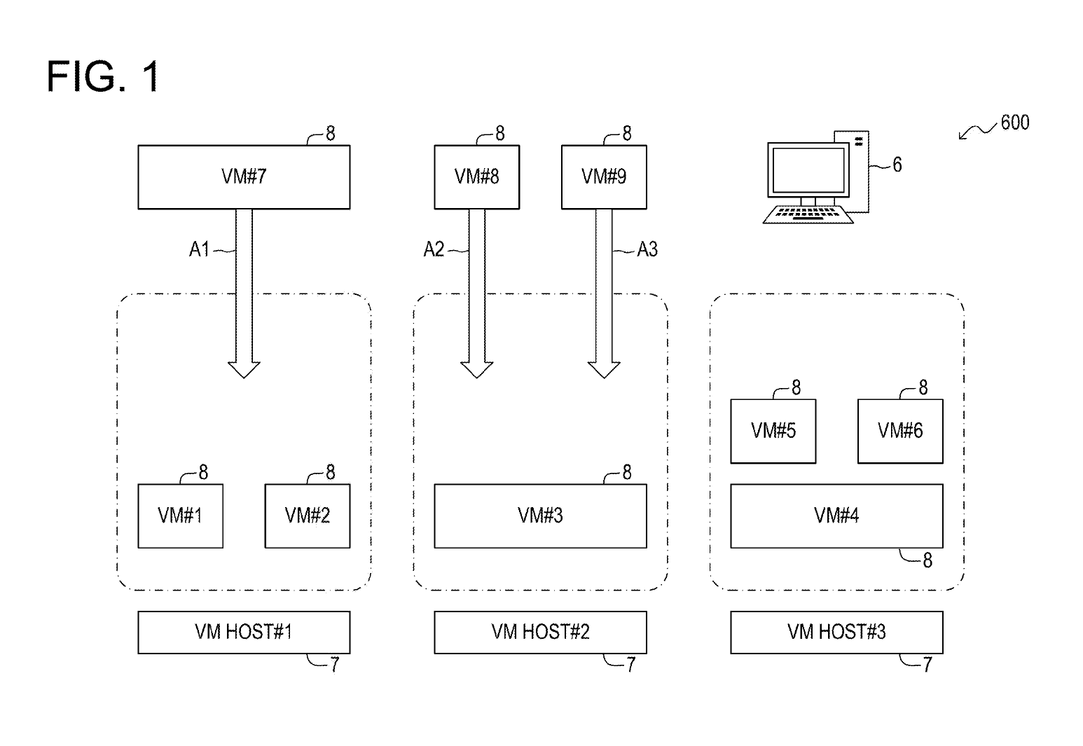

FIG. 1 is a view for explaining an example of a VM deployment process as a related example.

An information processing system 600 illustrated in FIG. 1 includes a management server 6 and plural (three in the illustrated example) VM hosts 7. The VM hosts 7 may be referred to as VM host#1 to VM host#3.

In the example illustrated in FIG. 1, six VMs 8 (which may be referred to as “VM#1 to VM#6”) are deployed in the three VM hosts 7. Specifically, VM#1 and VM#2 are deployed in the VM host#1, VM#3 is deployed in the VM host#2, and VM#4 to VM#6 are deployed in the VM host#3. Further, in the example illustrated in FIG. 1, the data volumes of VM#1, VM#2, VM#5, and VM#6 are the same, and the data volumes of VM#3 and VM#4 are the same. The data volumes of VM#1, VM#2, VM#5, and VM#6 are smaller than the data volumes of VM#3 and VM#4. Further, the data capacities of the VM hosts 7 are the same.

Here, an example will be described in which three new VMs 8 (which may be referred to as “VM#7 to VM#9”) are deployed in the VM hosts 7. The data volume of VM#7 is the same as the data volumes of VM#3 and VM#4, and the data volumes of VM#8 and VM#9 are the same as the data volumes of VM#1, VM#2, VM#5, and VM#6.

The management server 6 deploys VM#7 to VM#9 in the VM hosts 7 so that the loads among the plural VM hosts 7 are leveled. In other words, the management server 6 deploys VM#7 to VM#9 in the VM hosts 7 so that the data volumes of the VMs 8 deployed in the VM hosts 7 are leveled.

In the example illustrated in FIG. 1, first, the management server 6 deploys VM#7 in the VM host#1 having the largest empty space (see reference symbol A1).

Next, the management server 6 deploys VM#8 in the VM host#2 having the largest empty space after VM#7 is deployed (see reference symbol A2).

Then, the management server 6 deploys VM#9 in the VM host#2 having the largest empty space after VM#8 is deployed (see reference symbol A3).

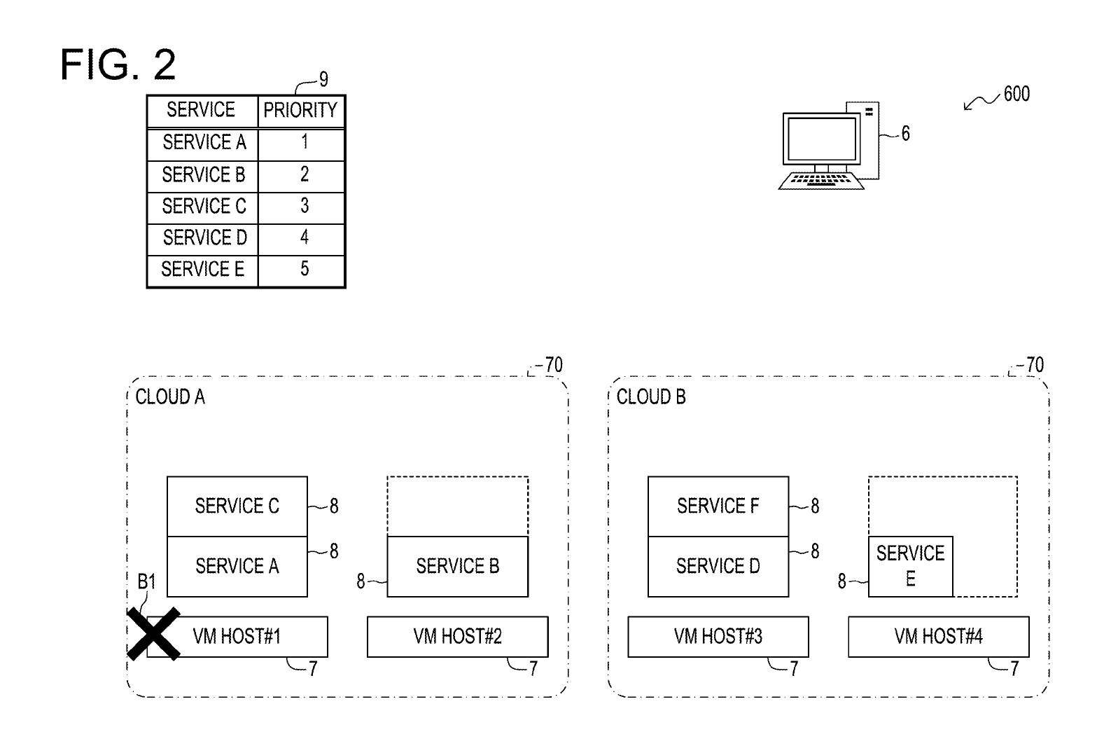

FIGS. 2 to 5 are views for explaining an example of a VM migration process as a related example.

The VMs 8 illustrated in FIG. 1 may be referred to as services 8, as illustrated in FIGS. 2 to 5. The services 8 may also be referred to as services A to E. In the examples illustrated in FIGS. 2 to 5, the data volumes of the services A to D and F are the same, and the data volume of the service E is smaller than the data volumes of the services A to D and F. Further, the data capacities in the VM hosts 7 are the same.

In the example illustrated in FIGS. 2 to 5, the management server 6 executes a VM migration process based on a priority table 9. The priority table 9 represents the priority of restoration of the services 8 when a failure occurs in the VM hosts 7 on which the services 8 are installed. A lower priority indicates a higher order of restoration of the services 8. In the examples illustrated in FIGS. 2 to 5, priorities “1” to “5” are associated with the services A to E, respectively.

In the example illustrated in FIG. 2, the services A and C are deployed in the VM host#1 and the service B is deployed in the VM host#2. In addition, the services D and F are deployed in the VM host#3 and the service E is deployed in the VM host#4.

The VM hosts 7 may be deployed in a cloud 70 (which may be referred to as a “cloud A or B”). In the example illustrated in FIG. 2, the VM host#1 and the VM host#2 are deployed in the cloud A, and the VM host#3 and the VM host#4 are deployed in the cloud B.

Here, it is assumed that an abnormality such as a failure has occurred in the VM host#1 (see reference symbol B1 in FIG. 2).

From the priority table 9, the management server 6 refers to the priorities of the services A and C deployed in the VM host#1 in which an abnormality has occurred. In this example, the priority of the service A is 1 and the priority of the service C is 3. That is, the priority of the service A is higher than the priority of the service C.

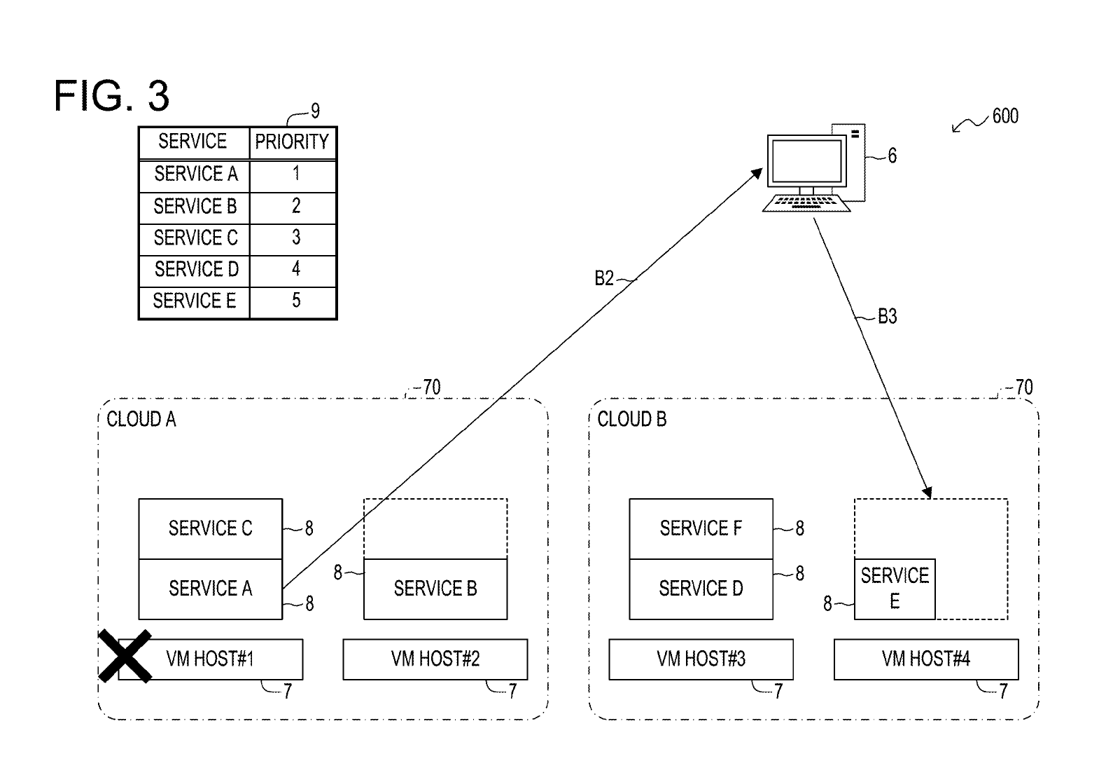

First, the management server 6 determines to migrate the service A having the highest priority in the VM host#1 in which an abnormality has occurred (see reference symbol B2 in FIG. 3). The management server 6 determines the VM host#4 having the largest empty space among the VM hosts 7 to which the service A may be migrated, as the migration destination of the service A (see reference symbol B3 in FIG. 3).

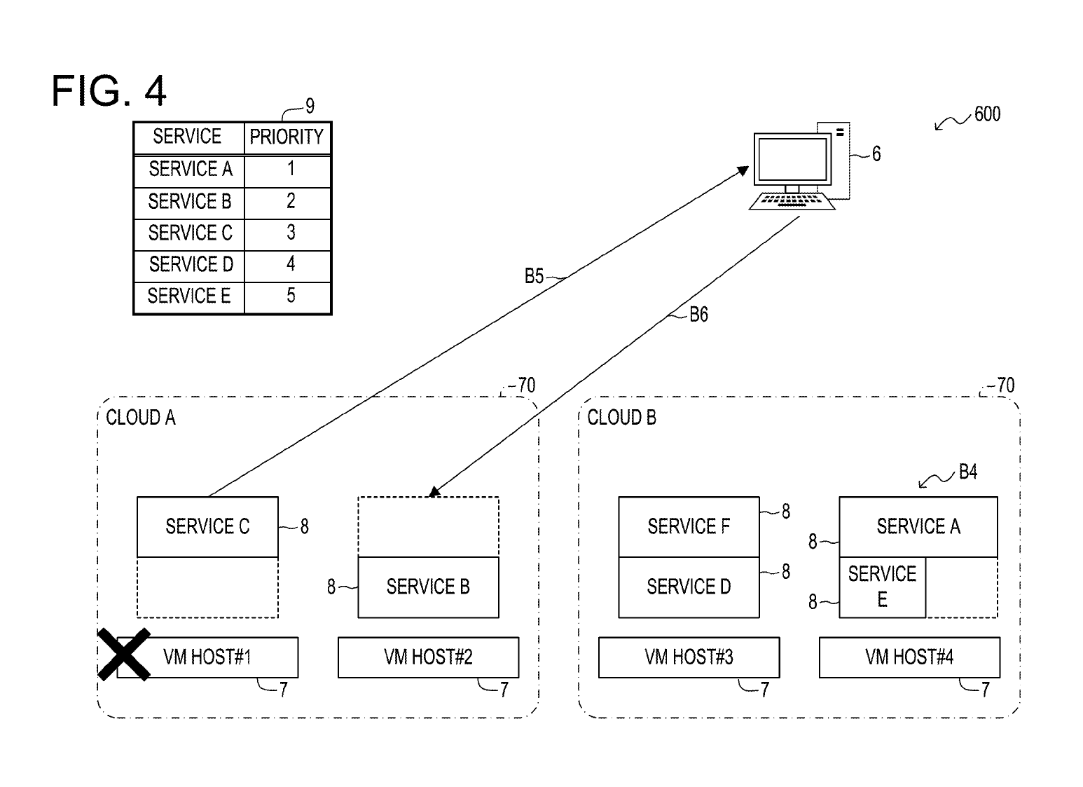

Then, the service A is deployed in the migration destination VM host#4 (see reference symbol B4 in FIG. 4).

The management server 6 determines to migrate the service C with the next highest priority in the VM host#1 in which an abnormality has occurred (see reference symbol B5 in FIG. 4). The management server 6 determines the VM host#2 having the largest empty space after migrating the service A among the VM hosts 7 to which the service C may be migrated, as the migration destination of the service C (see reference symbol B6 in FIG. 4).

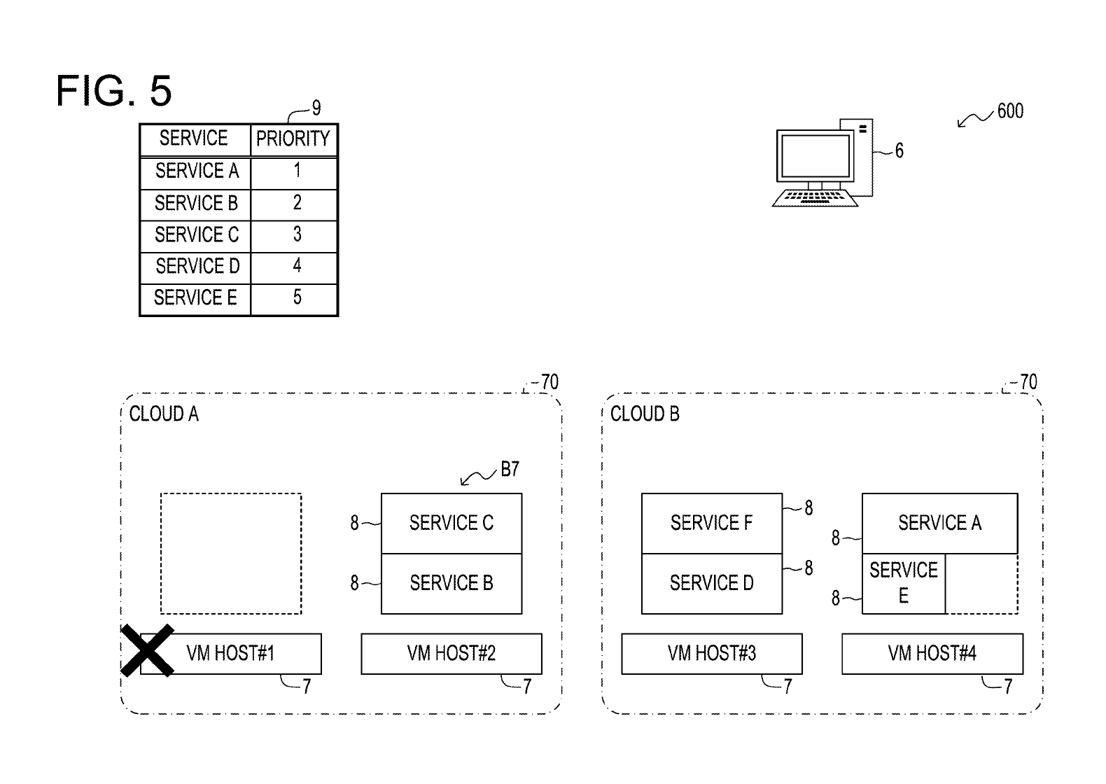

Then, the service C is deployed in the migration destination VM host#2 (see reference symbol B7 in FIG. 5).

However, in the VM migration process illustrated in FIGS. 2 to 5, the migration is started in order from a VM with the higher restoration priority, but the time required for data transfer between the VM hosts is not taken into consideration and it may be delayed to complete the restoration of the VM with the higher restoration priority.

### [B] One Example of Embodiment

### [B-1] System Configuration Example

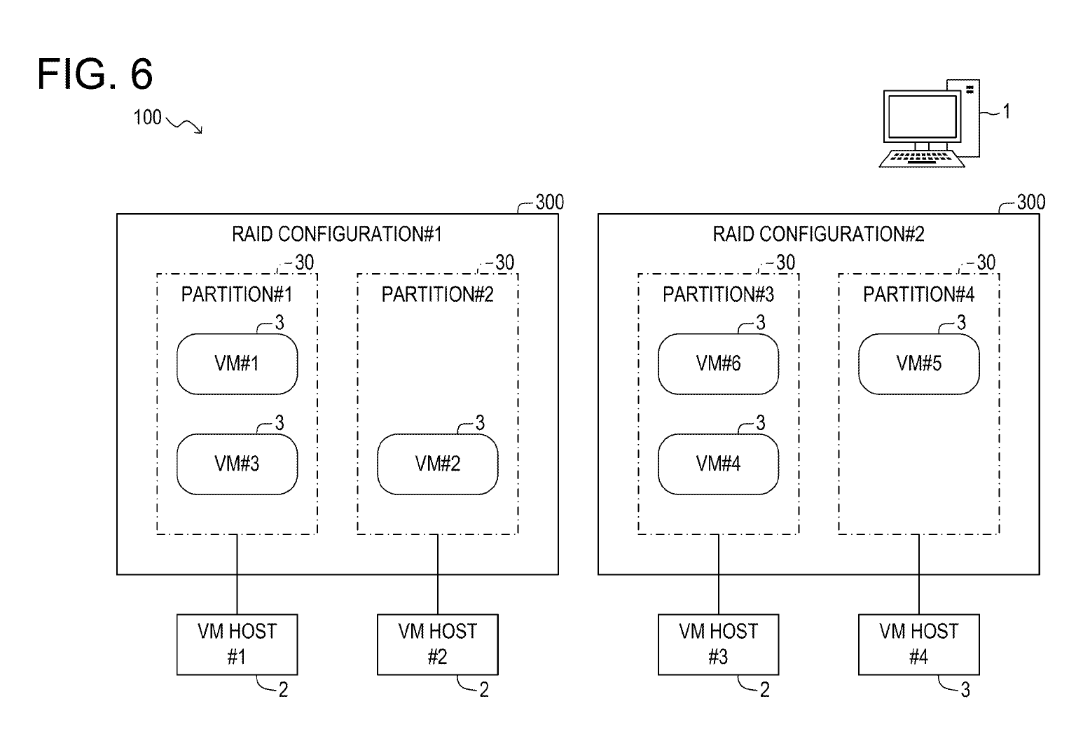

FIG. 6 is a view illustrating a configuration example of an information processing system 100 as an example of the embodiment.

The information processing system 100 illustrated in FIG. 6 includes a management server 1 and plural (four in the illustrated example) VM hosts 2. The VM host 2 may be referred to as VM host#1 to VM host#4.

In the example illustrated in FIG. 6, six VMs 3 (which may be referred to as “VM#1 to VM#6”) are deployed in the four VM hosts 2. Specifically, VM#1 and VM#3 are deployed in the VM host#1, VM#2 is deployed in the VM host#2, VM#4 and VM#6 are deployed in the VM host#3, and VM#5 is deployed in the VM host#4.

In the information processing system 100, a RAID (Redundant Arrays of Inexpensive Disks) configuration 300 (which may be referred to as “RAID configuration#1 or RAID configuration#2”) may be defined in order to improve the redundancy of the VMs 3. In the example illustrated in FIG. 6, the VM host#1 and the VM host#2 are coupled to the RAID configuration#1, and the VM host#3 and the VM host#4 are coupled to the RAID configuration#2.

Further, each RAID configuration 300 may be divided into plural partitions 30 (which may be referred to as “partition#1 to partition#4”). In the example illustrated in FIG. 6, the RAID configuration#1 is divided into partition#1 and partition#2, and the RAID configuration#2 is divided into partition#3 and partition#4. The VM host#1 deploys VM#1 and VM#3 belonging to partition#1, the VM host#2 deploys VM#2 belonging to partition#2, the VM host#3 deploys VM#4 and VM#6 belonging to partition#3, and the VM host#4 deploys VM#5 belonging to partition#4.

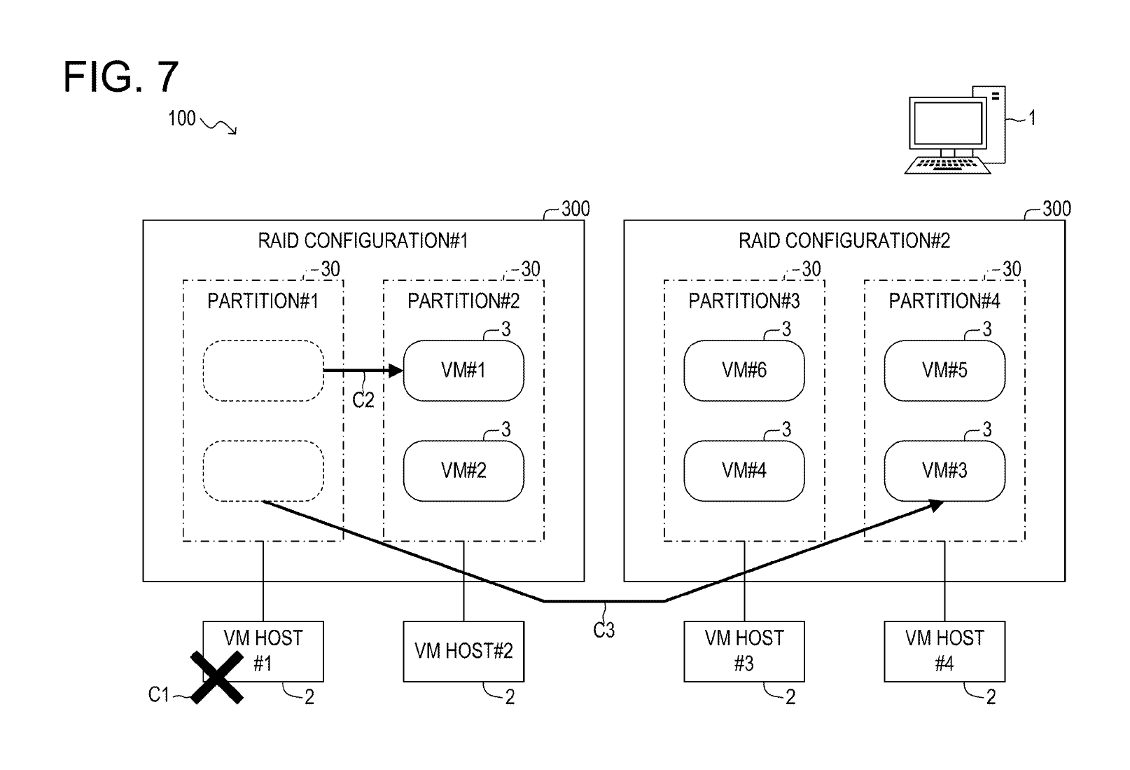

FIG. 7 is a view illustrating an example of the VM migration process in the information processing system 100 illustrated in FIG. 6.

Here, when an abnormality such as a failure occurs in the VM host#1 (see reference symbol C1), based on the priority of each VM 2 and the data transfer rate between the VM hosts 2, for example, VM#1 is migrated from the VM Host#1 to the VM host#2 (see reference symbol C2). In addition, VM#3 is migrated from the VM host#1 to the VM host#4 (see reference symbol C3).

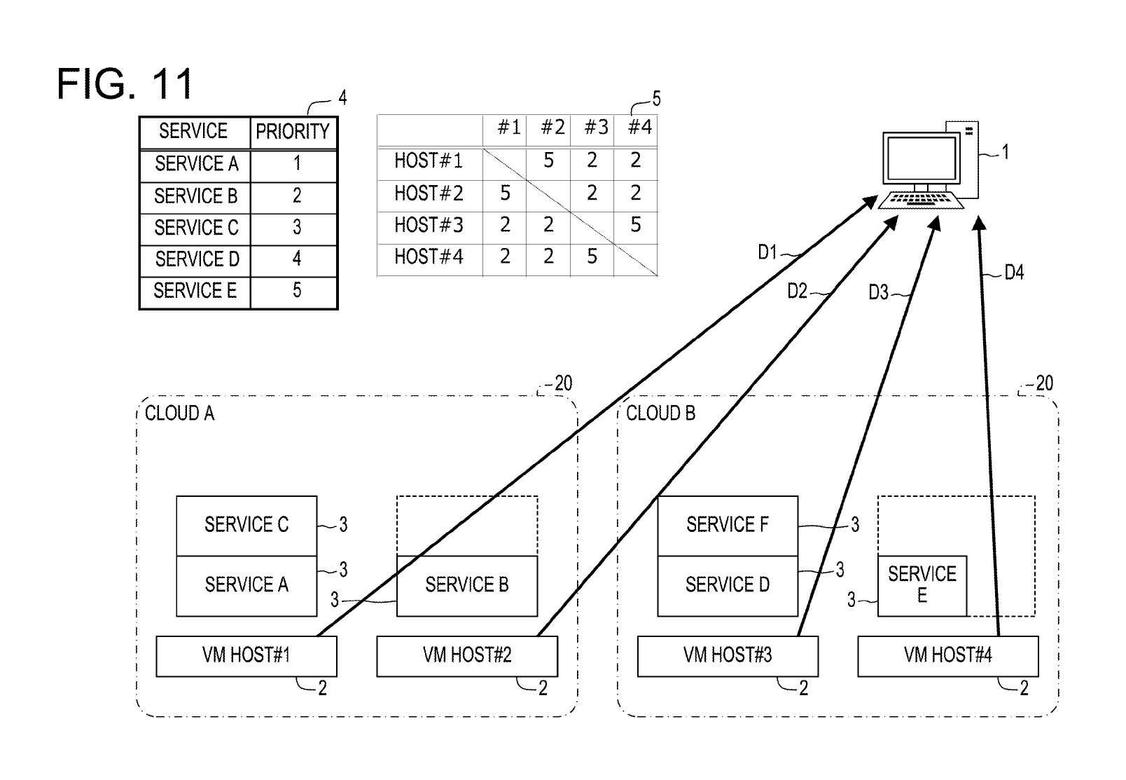

Details of the VM migration process in the example of the embodiment will be described later with reference to FIGS. 11 to 14 and so on.

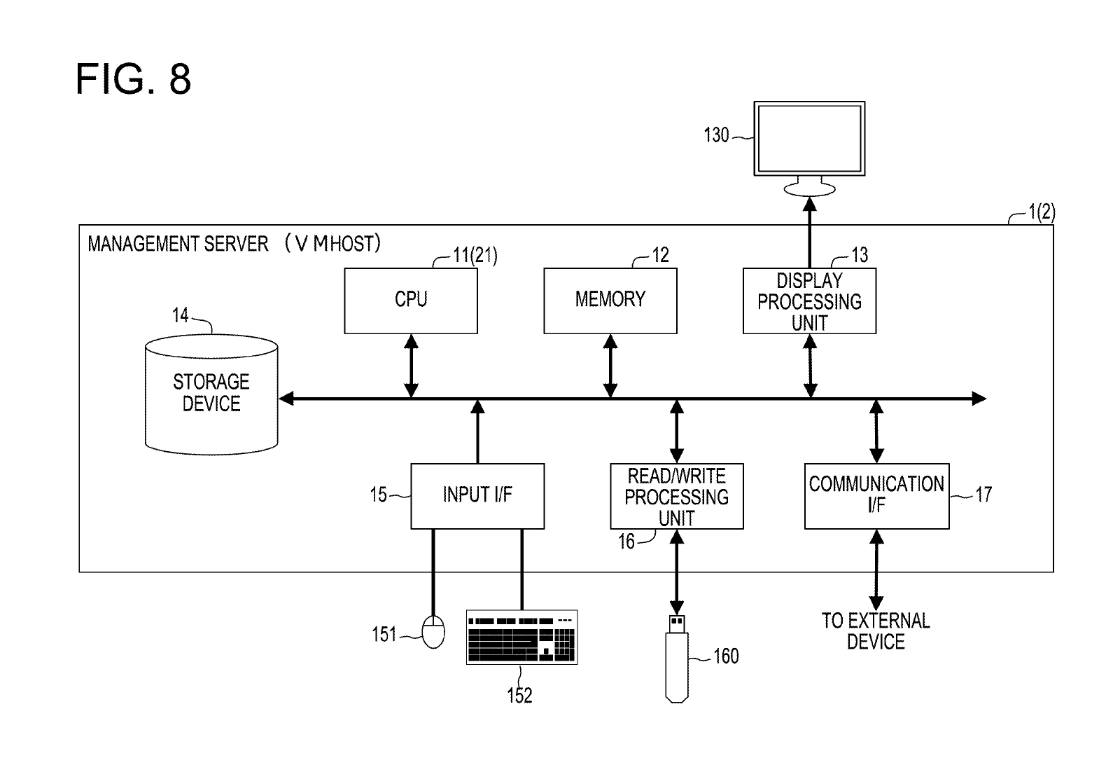

FIG. 8 is a view illustrating a hardware configuration example of the management server 1 and the VM host 2 illustrated in FIG. 6.

The management server 1 is an example of an information processing apparatus and includes a central processing unit (CPU) 11, a memory 12, a display processing unit 13, a storage device 14, an input interface (I/F) 15, a read/write processing unit 16, and a communication I/F 17.

The VM host 2 is an example of a host device and includes a CPU 21, a memory 12, a display processing unit 13, a storage device 14, an input I/F 15, a read/write processing unit 16, and a communication I/F 17.

The memory 12 is illustratively a storage device that includes a read only memory (ROM) and a random access memory (RAM). A program such as BIOS (Basic Input/Output System) may be written in the ROM of the memory 12. The software program of the memory 12 may be appropriately read and executed by the CPU 11 or 21. Further, the RAM of the memory 12 may be used as a primary recording memory or a working memory.

The display processing unit 13 is coupled to a display device 130 and controls the display device 130. The display device 130 is a liquid crystal display, a cathode ray tube (CRT), an electronic paper display, or the like and displays various kinds of information for an operator or the like. The display device 130 may be combined with an input device and may be, for example, a touch panel.

The storage device 14 is illustratively a device that stores data in a readable and writable manner, for example, a hard disk drive (HDD), a solid state drive (SSD), or a storage class memory (SCM).

The input I/F 15 is coupled to and controls an input device such as a mouse 151 or a keyboard 152. The mouse 151 and the keyboard 152 are examples of the input device and an operator performs various input operations via this input device.

The read/write processing unit 16 is configured so that a recording medium 160 may be mounted. The read/write processing unit 16 is configured to be capable of reading information recorded on the recording medium 160 in a state in which the recording medium 160 is mounted. In this example, the recording medium 160 has portability. For example, the recording medium 160 is a flexible disk, an optical disk, a magnetic disk, a magneto-optical disk, a semiconductor memory, or the like.

The communication I/F 17 is an interface that communicably connects the management server 1 and the VM host 2 (i.e., enabling communication with external devices).

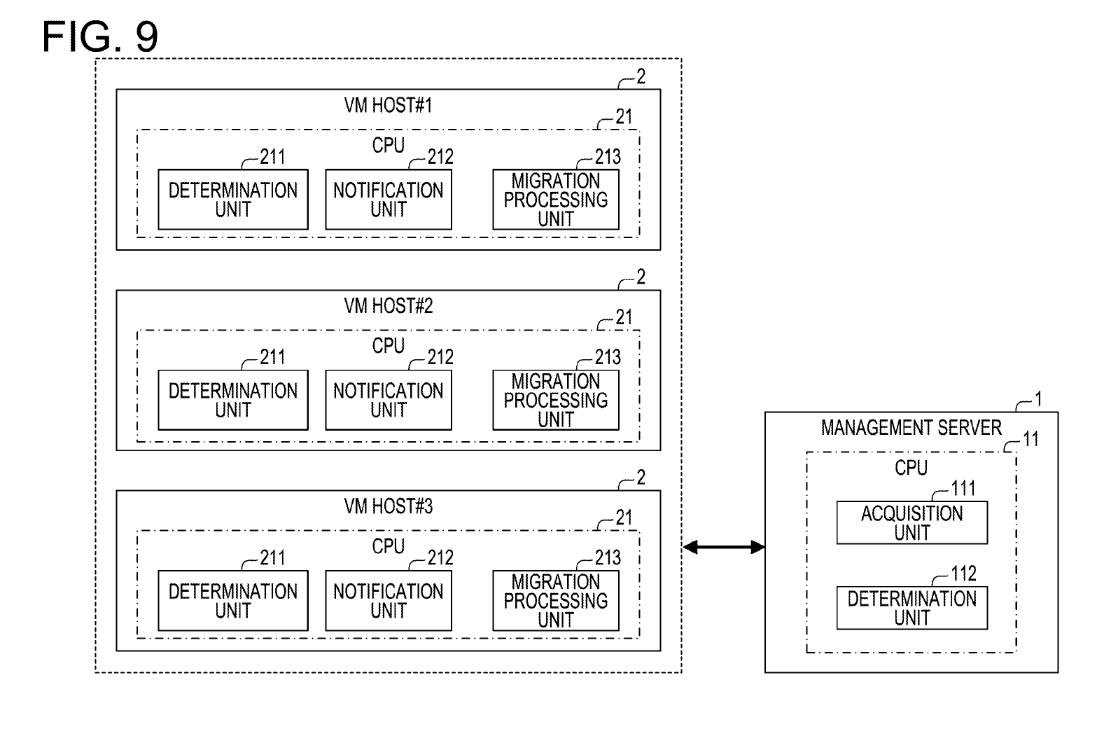

FIG. 9 is a view illustrating a functional configuration example of the management server 1 and the VM host 2 illustrated in FIG. 6.

The CPUs 11 and 21 are processing devices that perform various controls and computations, and implement various functions by executing an operating system (OS) and programs stored in the memory 12. That is, as illustrated in FIG. 9, the CPU 11 of the management server 1 functions as an acquisition unit 111 and a determination unit 112. Further, the CPU 21 of the VM host 2 functions as a measurement unit 211, a notification unit 212, and a migration processing unit 213.

The programs that implement the functions of the acquisition unit 111, the determination unit 112, the measurement unit 211, the notification unit 212, and the migration processing unit 213 are provided, for example, in a form recorded on the recording medium 160. A computer reads the program from the recording medium 160 via the read/write processing unit 16, transfers the program to an internal storage device or an external storage device, stores the program therein, and uses the program. Further, the program may be recorded in a storage device (recording medium) such as a magnetic disk, an optical disk or a magneto-optical disk and may be provided from the storage device to the computer via a communication path.

In implementing the functions as the acquisition unit 111, the determination unit 112, the measurement unit 211, the notification unit 212, and the migration processing unit 213, the program stored in the internal storage device (the memory 12 in this embodiment) is executed by a microprocessor (the CPU 11 or 21 in this embodiment) of the computer. At this time, the computer may read and execute the program recorded on the recording medium.

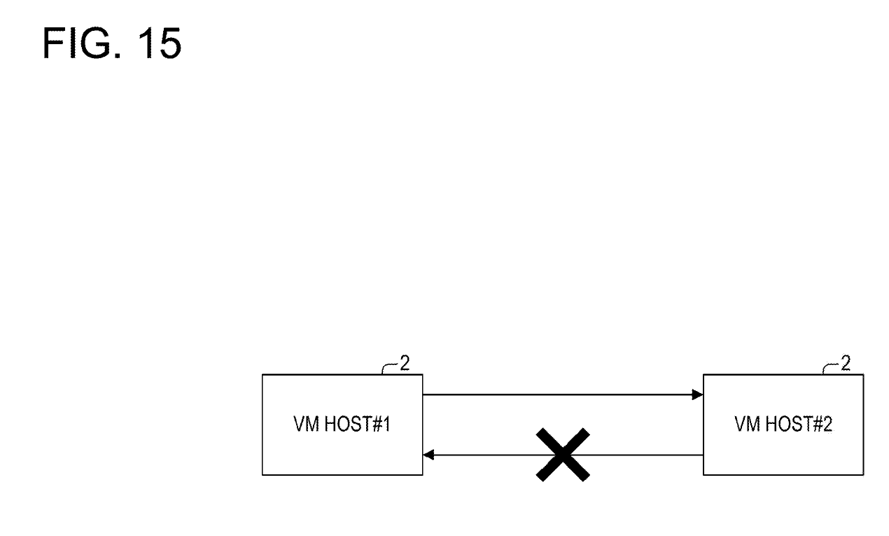

The measurement unit 211 of the VM host 2 measures the data transfer rate between plural VM hosts 2. Details of the transfer rate measuring process by the measurement unit 211 will be described later with reference to FIGS. 15 to 20 and so on.

The notification unit 212 of the VM host 2 notifies the management server 1 of the data transfer rate notified by the measurement unit 211.

In accordance with the determination made by the management server 1, the migration processing unit 213 migrates the to-be-migrated VM 3 from the migration source VM host 2 to the migration destination VM host 2.

The acquisition unit 111 of the management server 1 acquires the data transfer rate between plural VM hosts 2 notified from the notification unit 212 of each VM host 2. In other words, the acquisition unit 111 acquires the data transfer rate between the migration source VM host 2 and plural migration destination VM hosts 2.

The determination unit 112 of the management server 1 determines the VM host 2 as the migration destination of each VM 3 among the plural migration destination VM hosts 2 in the order of priority set for each of the plural VMs 3, based on the data transfer rate acquired by the acquisition unit 111. Details of the VM migrating process by the determination unit 112 will be described later with reference to FIGS. 11 to 14 and so on.

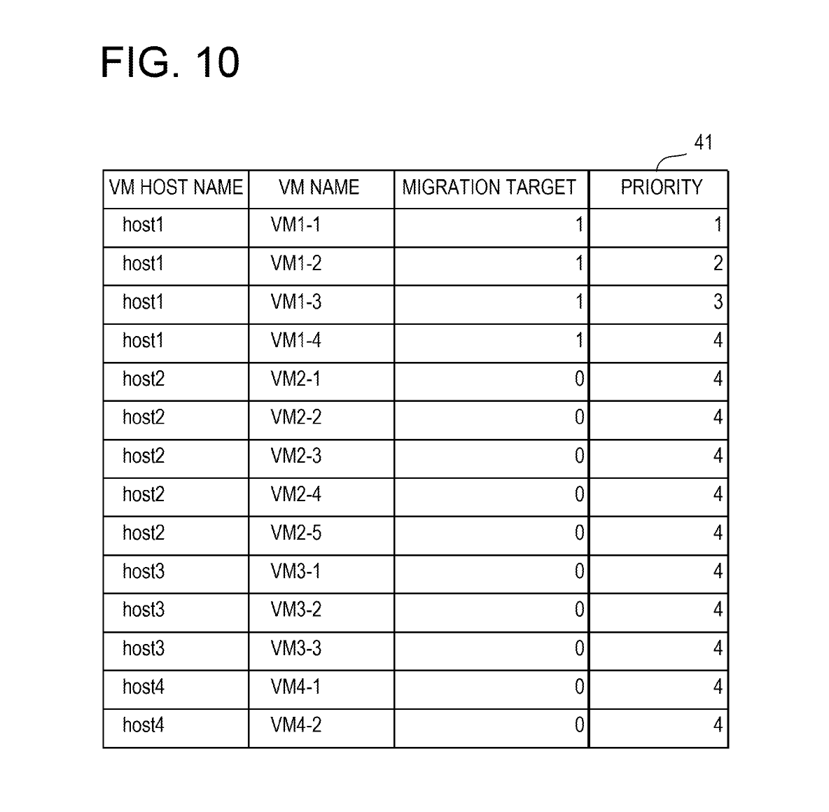

FIG. 10 is a view illustrating an example of a priority table 41 used in the information processing system 100 illustrated in FIG. 6.

In the priority table 41 illustrated in FIG. 10, “VM host name”, “VM name”, “migration target”, and “priority” are associated with each other.

“VM host name” indicates an identifier of the VM host 2 where the VM 3 is deployed.

“VM name” indicates an identifier of the deployed VM 3.

The terms “migration target” indicates whether the VM 3 is a migration target. In the example illustrated in FIG. 10, when “1” is set as the “migration target”, the VM 3 is a migration target. When “0” is set in the “migration target”, the VM 3 is not a migration target. For example, when an abnormality such as a failure occurs in the VM host 2, the “migration target” of the VM 3 deployed in the VM host 2 in which the abnormality occurs is changed from “0” to “1”.

“Priority” indicates a priority of restoration of each VM 3 when a failure occurs in the VM host 2 on which the VM 3 is mounted. A smaller value of the “priority” indicates a higher priority of restoration of the VM 3. In the example illustrated in FIG. 10, one of “1” to “4” is associated with each VM as “priority”.

In the example illustrated in FIG. 10, for example, for the VM 3 having “VM host name” of “host1” and “VM name” of “VM1-1”, the “migration target” is set to “1” and the “priority” is set to “1”. For example, for the VM 3 having “VM host name” of “host2” and “VM name” of “VM2-1”, the “migration target” is set to “0” and the “priority” is set to “4”.

That is, “VM1-1” of “host1” is set as a migration target, whereas “VM2-1” of “host2” is not set as a migration target. In addition, the priority of “VM1-1” of “host1” is higher than the priority of “VM2-1” of “host2”.

FIGS. 11 to 14 are views for explaining an example of the VM migration process in the information processing system 100 illustrated in FIG. 6.

The VMs 3 illustrated in FIGS. 6 and 7 may be referred to as services 3, as illustrated in FIGS. 11 to 14. The service 3 may also be referred to as services A to F. In the examples illustrated in FIGS. 11 to 14, the data volumes of the services A to D and F are the same, and the data volume of the service E is smaller than the data volumes of the services A to D and F. Further, the data volumes of the VM hosts 2 are the same.

In the example illustrated in FIGS. 11 to 14, the management server 1 executes the VM migration process based on a priority table 4. The priority table 4 represents the priority of restoration of the services 3 when a failure occurs in the VM hosts 2 on which the services 3 are installed. A lower priority indicates a higher order of restoration of the services 3. In the examples illustrated in FIGS. 11 to 14, priorities “1” to “5” are associated with the services A to E, respectively.

The priority table 4 illustrated in FIGS. 11 to 14 corresponds to the priority table 41 illustrated in FIG. 10. The term “service” of the priority table 4 illustrated in FIGS. 11 to 14 corresponds to “VM name” of the priority table 41 illustrated in FIG. 10. Further, “VM host name” and “migration target” in the priority table 41 illustrated in FIG. 10 are not represented in the priority table 4 illustrated in FIGS. 11 to 14.

In the example illustrated in FIG. 11, the services A and C are deployed in the VM host#1 and the service B is deployed in the VM host#2. In addition, the services D and F are deployed in the VM host#3, and the service E is deployed in the VM host#4.

The VM hosts 2 are deployed in a cloud 20 (which may be referred to as a “cloud A or B”). In the example illustrated in FIG. 11, the VM host#1 and the VM host#2 are deployed in the cloud A, and the VM host#3 and the VM host#4 are deployed in the cloud B.

The acquisition unit 111 of the management server 1 acquires the data transfer rate between VM hosts 2 measured in real time for each VM host 2 (see reference symbols D1 to D4 in FIG. 11).

In the examples illustrated in FIGS. 11 to 14, as represented in a transfer rate table 5, the transfer rate between the VM host#1 and the VM host#2 and the transfer rate between the VM host#3 and the VM host#4 are 5 GB/s. The transfer rate between the VM host#1 and the VM host#3, the transfer rate between the VM host#1 and the VM host#4, the transfer rate between the VM host#2 and the VM host#3, and the transfer rate between the VM host#2 and the VM host#4 are 2 GB/s.

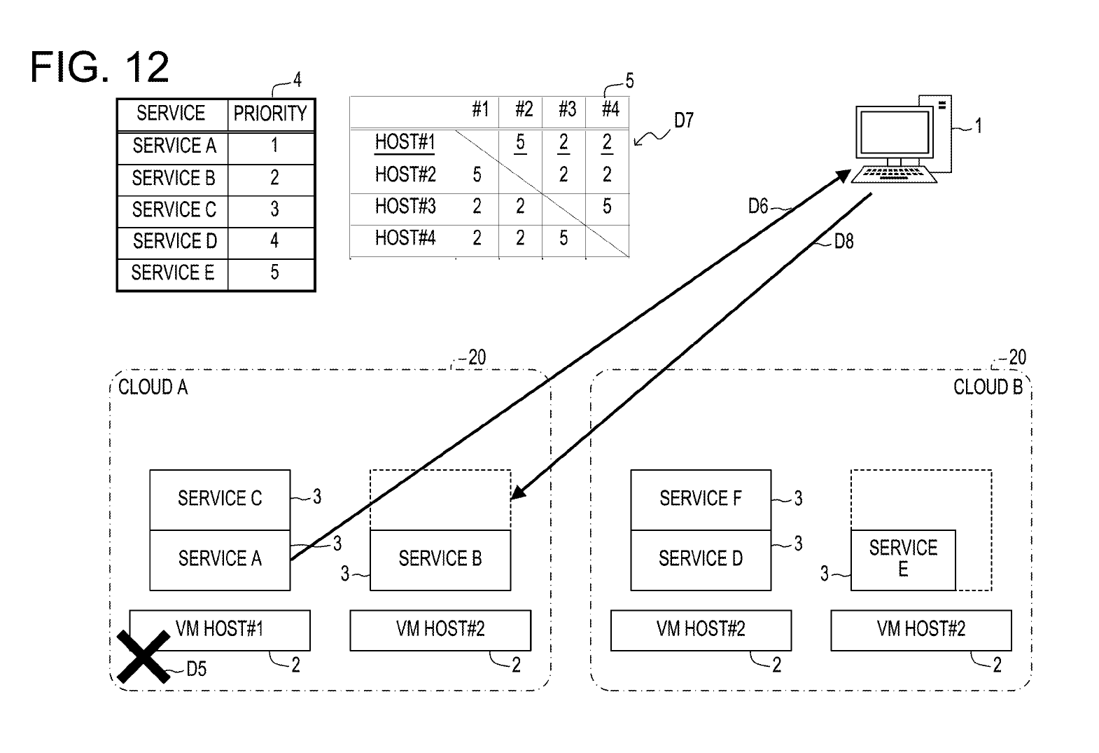

Here, it is assumed that an abnormality such as a failure has occurred in the VM host#1 (see reference symbol D5 in FIG. 12).

The determination unit 112 of the management server 1 refers to the priorities of the services A and C deployed in the VM host#1 in which an abnormality has occurred, from the priority table 4. In this example, the priority of the service A is 1 and the priority of the service C is 3. That is, the priority of the service A is higher than the priority of the service C.

First, the determination unit 112 determines to migrate the service A having the highest priority in the VM host#1 in which an abnormality has occurred (see reference symbol D6 in FIG. 12).

The determination unit 112 refers to the transfer rate table 5 (see reference symbol D7 in FIG. 12) to determine the VM host#2 having the largest transfer rate of 5 GB/s from the VM host#1 among the VM hosts 2 to which the service A may be migrated, as the migration destination of the service A (see reference symbol D8 in FIG. 12).

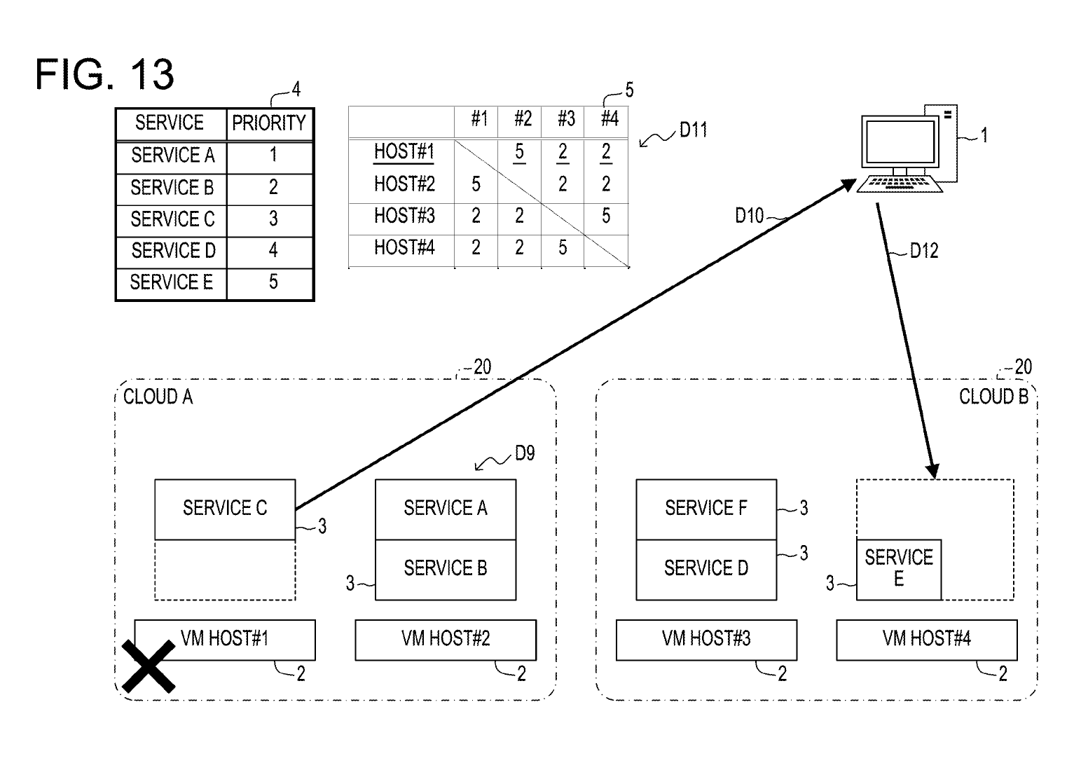

Then, the service A is deployed in the migration destination VM host#2 (see reference symbol D9 in FIG. 13).

The determination unit 112 of the management server 1 determines to migrate the service C having the next highest priority in the VM host#1 in which the abnormality has occurred (see reference symbol D10 in FIG. 13).

The determination unit 112 refers to the transfer rate table 5 (see reference symbol D11 in FIG. 13). Then, the determination unit 112 decides the VM host#4 having the largest transfer rate of 2 GB/s from the VM host#1 among the VM hosts 2 to which the service C may be migrated after the service A is migrated, as the migration destination of the service C (see reference symbol D12 in FIG. 13). After the service A is migrated, since the VM host#2 having the transfer rate of 5 GB/s has no empty space, the service C is unable to be migrated. In addition, since the VM host#3 having the same transfer rate of 2 GB/s as the VM host#4 has no empty space, the service C is unable to be migrated.

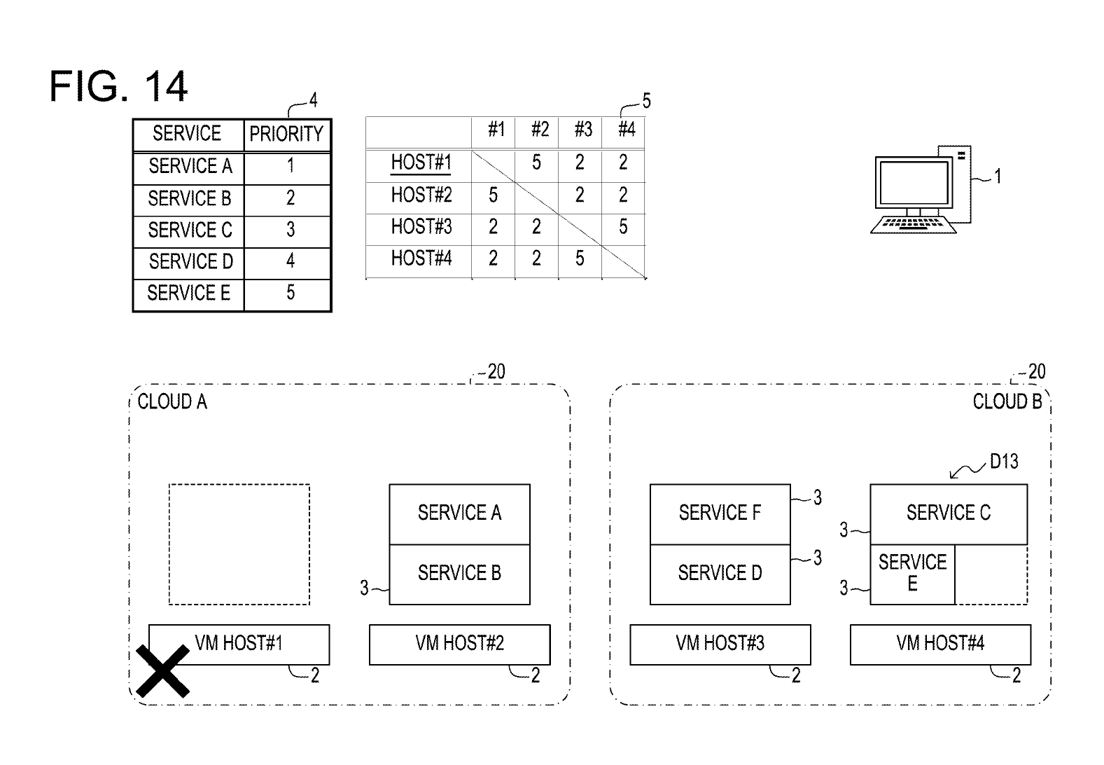

Then, the service C is deployed in the migration destination VM host#4 (see reference symbol D13 in FIG. 14).

That is, for the VM 3 with a relatively high priority, the determination unit 112 determines the VM host 2 coupled to the migration source VM host 2 via a communication path with a relatively high data transfer rate, as the migration destination of the VM 3. For the VM 3 having a relatively low priority, the determination unit 112 determines the VM host 2 coupled to the migration source VM host 2 via a communication path with a relatively low data transfer rate, as the migration destination of the VM 3. Thus, in the information processing system 100 according to the example of the embodiment, it is possible to start and complete the migration process between the VM hosts 2 of the VMs 3 with a relatively high restoration priority at an early stage.

Here, as illustrated in FIGS. 2 to 5 in the above-described related example, a case is considered where the service A with a relatively higher priority is migrated to the VM host#4 and the service C with a relatively lower priority is migrated to the VM host#2. The VM host 2 and the priority of the deployment destination of the services A to F at the time of occurrence of an abnormality in the VM host#1 illustrated in FIG. 2 are the same as the VM host 2 and the priority of the deployment destination of the services A to F at the time of occurrence of an abnormality in the VM host#1 illustrated in FIG. 12.

In the related example illustrated in FIGS. 2 to 5, it is assumed that the data volumes of the to-be-migrated services A and C are both 60 GB. Further, in the related examples illustrated in FIGS. 2 to 5, similarly to the example of the embodiment illustrated in FIGS. 12 to 14, it is assumed that the transfer rate from the VM host#1 to the VM host#2 is 5 GB/s, and the transfer rate from the VM Host#1 to the VM Host#4 is 2 GB/s.

In this case, migrating the service A with a relatively higher priority from the VM host#1 to the VM host#4 requires time of 30 seconds (=60 GB/2 GB/s). In the meantime, migrating the service C with a relatively lower priority from the VM host#1 to the VM host#2 requires time of 12 seconds (=60 GB/5 GB/s). That is, in the related example illustrated in FIGS. 2 to 5, the migration process of the service C with the relatively lower priority is completed earlier than the migration process of the service A with the relatively higher priority, restoring the service C earlier than the service A.

FIG. 15 is a view for explaining an example of a transfer rate measurement process between two VM hosts 2 in the information processing system 100 illustrated in FIG. 6.

The measurement unit 211 of each VM host 2 may measure the transfer rate only in the transmission path in one direction out of transfer rates in the transmission paths in two directions between the two VM hosts 2.

In the example illustrated in FIG. 15, the measurement unit 211 of the VM host#1 measures the transfer rate in the direction from the VM host#1 to the VM host#2, whereas the measurement unit 211 of the VM host#2 does not measure the transfer rate in the direction from the VM host#2 to the VM host#1.

When the transfer rate in one directional communication through the bidirectional communication paths between the VM hosts 2 is measured, the transfer rate between all the VM hosts 2 may be known.

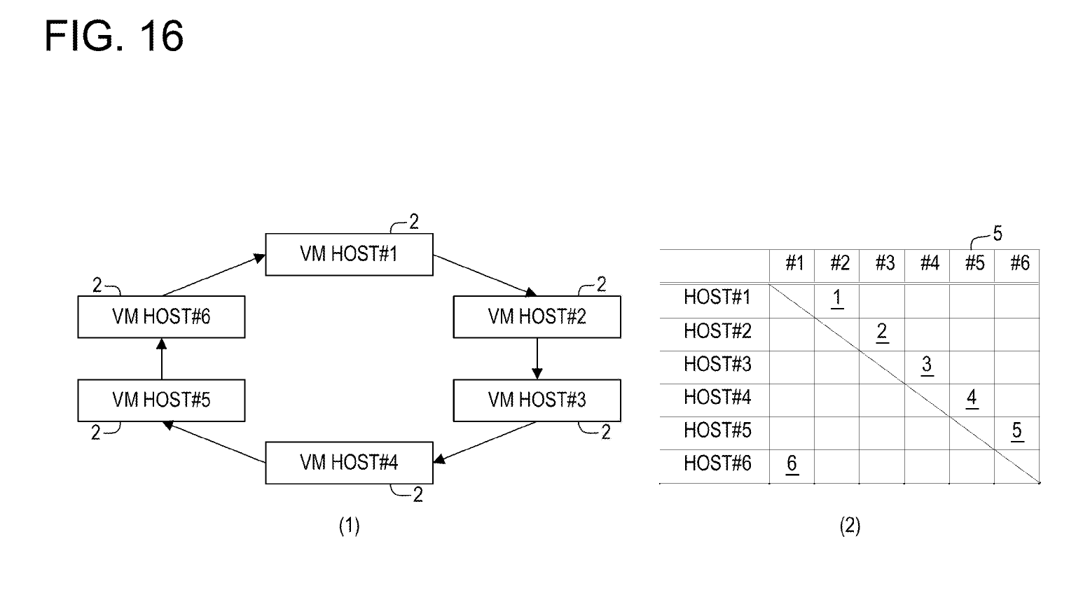

FIGS. 16 to 18 are views for explaining an example of the transfer rate measurement process between an even number of VM hosts 2 in the information processing system 100 illustrated in FIG. 6.

The number of VM hosts 2 for measuring the transfer rate is n (n is an even number of 4 or more) and the numbers of #1 to #n are set to the VM hosts 2 to be measured. In (1) of FIG. 16, six VM host#1 to VM host#6 are illustrated as the VM hosts 2.

The measurement unit 211 of each VM host 2 measures the transfer rate between the VM host and another VM host 2 to which a number higher by one than its own number is set. The measurement unit 211 of the VM host#n measures the transfer rate between the VM host#n and the VM host#1.

In (1) of FIG. 16, the VM host#1 measures the transfer rate between the VM host#1 and the VM host#2, the VM host#2 measures the transfer rate between the VM host#2 and the VM host#3, and the VM host#3 measures the transfer rate between the VM host#3 and the VM host#4. In addition, the VM host#4 measures the transfer rate between the VM host#4 and the VM host#5, the VM host#5 measures the transfer rate between the VM host#5 and the VM host#6, and the VM host#6 measures the transfer rate between the VM host#6 and the VM host#1.

In other words, the VM host#k measures the transfer rate in the direction to the VM host#k+1, the VM host#n−1 measures the transfer rate in the direction to the VM host#n, and the VM host#n measure the transfer rate in the direction to the VM host#1. Where, k is an integer of 1 or more and n−2 or less.

When the transfer rate measurement process illustrated in (1) of FIG. 16 is completed, a transfer rate table 5 illustrated in (2) of FIG. 16 is obtained. In the transfer rate table 5 illustrated in (2) of FIG. 16, six transfer rates 1 to 6 measured by the transfer rate measurement process illustrated in (1) of FIG. 16 are newly registered.

Next, the measurement unit 211 of each VM host 2 measures the transfer rate between the VM host 2 and another VM host 2 to which a number higher by two than its own number is set. The measurement units 211 of the VM host#n−1 and the VM host#n measure the transfer rates between the VM host#n−1 and the VM host#1, and between the VM host#n and the VM host#2, respectively.

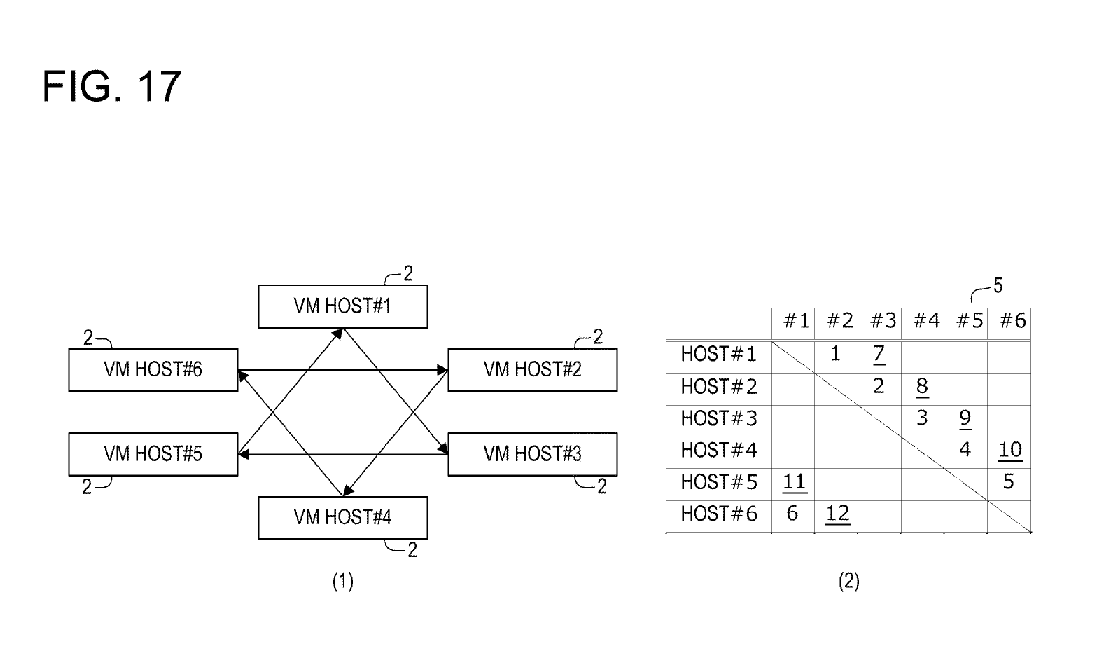

In (1) of FIG. 17, the VM host#1 measures the transfer rate between the VM host#1 and the VM host#3, the VM host#2 measures the transfer rate between the VM host#2 and the VM host#4, and the VM host#3 measures the transfer rate between the VM host#3 and the VM host#5. In addition, the VM host#4 measures the transfer rate between the VM host#4 and the VM host#6, the VM host#5 measures the transfer rate between the VM host#5 and the VM host#1, and the VM host#6 measures the transfer rate between the VM host#6 and the VM host#2.

In other words, the VM host#k measures the transfer rate in the direction to the VM host#k+2, the VM host#n−1 measures the transfer rate in the direction to the VM host#1, and the VM host#n measure the transfer rate in the direction to the VM host#2. Where, k is an integer of 1 or more and n−2 or less.

When the transfer rate measurement process illustrated in (1) of FIG. 17 is completed, a transfer rate table 5 illustrated in (2) of FIG. 17 is obtained. In the transfer rate table 5 illustrated in (2) of FIG. 17, six transfer rates 7 to 12 measured by the transfer rate measurement process illustrated in (1) of FIG. 17 are newly registered.

Among the measurement units 211 of the VM hosts 2, the measurement unit 211 of each of the VM host#1 to the VM host#n/2 measures the transfer rate between it and the VM host 2 to which a number higher by three than its own number is set.

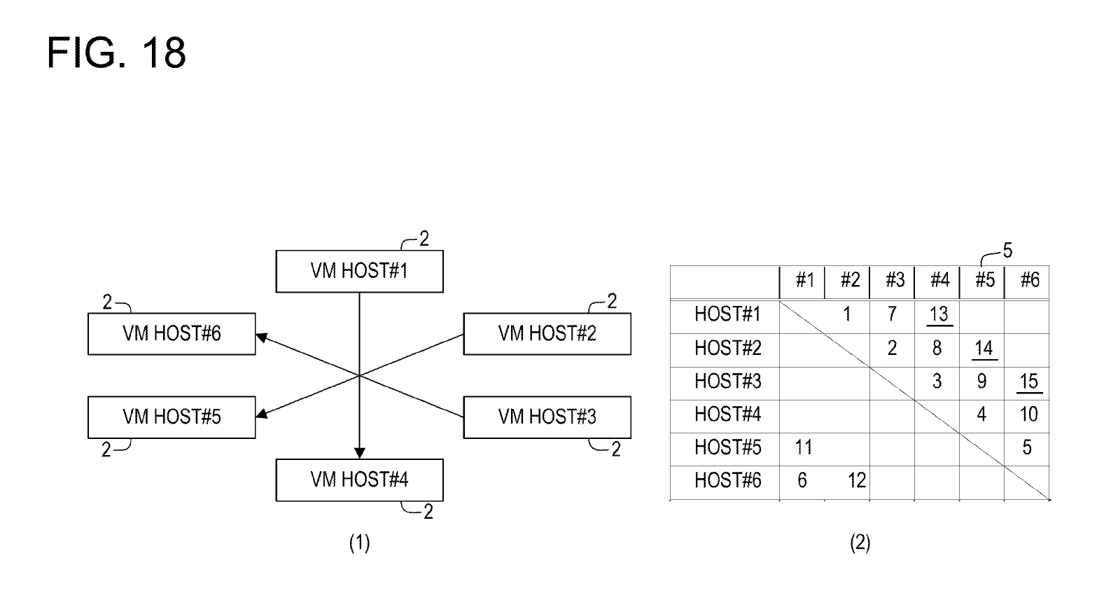

In (1) of FIG. 18, the VM host#1 measures the transfer rate between the VM host#1 and the VM host#4, the VM host#2 measures the transfer rate between the VM host#2 and the VM host#5, and the VM host#3 measures the transfer rate between the VM host#3 and the VM host#6.

In other words, the VM host#k measures the transfer rate in the direction to the VM host#k+3. Where, k is an integer of 1 or more and n/2 or less.

When the transfer rate measurement process illustrated in (1) of FIG. 18 is completed, a transfer rate table 5 illustrated in (2) of FIG. 18 is obtained. In the transfer rate table 5 illustrated in (2) of FIG. 18, three transfer rates 13 to 15 measured by the transfer rate measurement process illustrated in (1) of FIG. 18 are newly registered.

The transfer rate in one directional communication through the bidirectional communication paths between the VM hosts 2 is registered in the transfer rate table 5 illustrated in (2) of FIG. 18. That is, the transfer rate in the direction from the VM host#a to the VM host#b or the transfer rate in the direction from the VM host#b to the VM host#a is registered in the transfer rate table 5 illustrated in (2) of FIG. 18. Where, a and b are different integers of 1 or more and n or less.

When the transfer rate in one directional communication through the bidirectional communication paths between the VM hosts 2 is registered in the transfer rate table 5, the transfer rate between all the VM hosts 2 may be known.

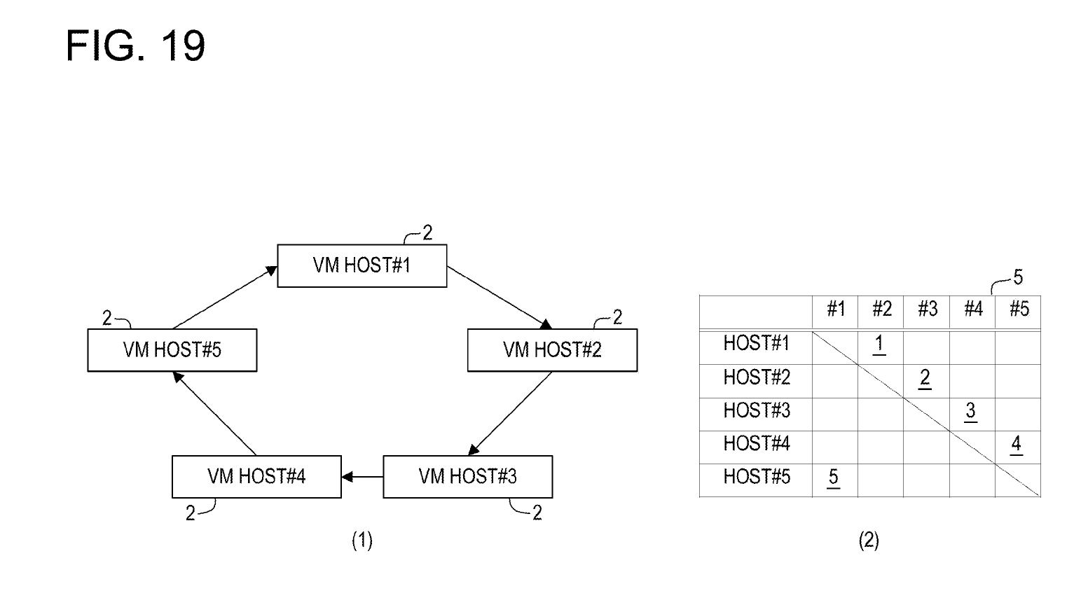

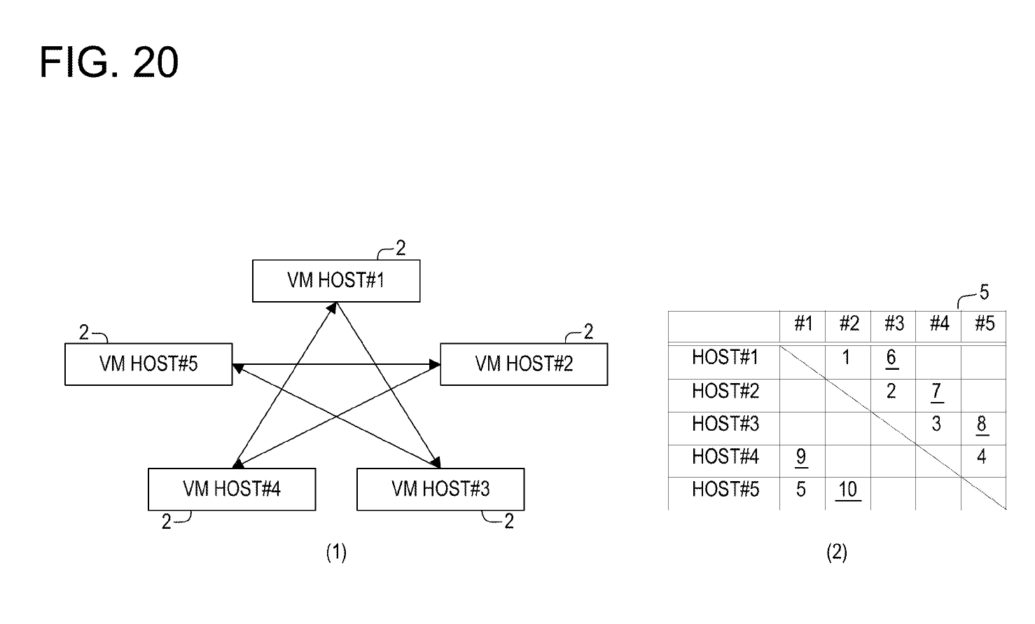

FIGS. 19 and 20 are views for explaining an example of the transfer rate measurement process between an odd number of VM hosts 2 in the information processing system 100 illustrated in FIG. 6.

The number of VM hosts 2 that measures the transfer rate is m (m is an odd number of 3 or more) and the numbers of #1 to #m are set to the VM hosts 2 to be measured. In (1) of FIG. 19, five VM host#1 to VM host#5 are represented as the VM hosts 2.

The measurement unit 211 of each VM host 2 measures the transfer rate between the VM host and another VM host 2 to which a number higher by one than its own number is set. The measurement unit 211 of the VM host#m measures the transfer rate between the VM host#m and the VM host#1.

In (1) of FIG. 19, the VM host#1 measures the transfer rate between the VM host#1 and the VM host#2, the VM host#2 measures the transfer rate between the VM host#2 and the VM host#3, and the VM host#3 measures the transfer rate between the VM host#3 and the VM host#4. In addition, the VM host#4 measures the transfer rate between the VM host#4 and the VM host#5, and the VM host#5 measures the transfer rate between the VM host#5 and the VM host#1.

In other words, the VM host#j measures the transfer rate in the direction to the VM host#j+1, the VM host#m−1 measures the transfer rate in the direction to the VM host#m, and the VM host#m measure the transfer rate in the direction to the VM host#1. Where, j is an integer of 1 or more and m−2 or less.

When the transfer rate measurement process illustrated in (1) of FIG. 19 is completed, a transfer rate table 5 illustrated in (2) of FIG. 19 is obtained. In the transfer rate table 5 illustrated in (2) of FIG. 19, five transfer rates 1 to 5 measured by the transfer rate measurement process illustrated in (1) of FIG. 19 are newly registered.

Next, the measurement unit 211 of each VM host 2 measures the transfer rate between the VM host 2 and another VM host 2 to which a number higher by two than its own number is set. The measurement units 211 of the VM host#m−1 and the VM host#m measure the transfer rates between the VM host#m−1 and the VM host#1 and between the VM host#m and the VM host#2, respectively.

In (1) of FIG. 20, the VM host#1 measures the transfer rate between the VM host#1 and the VM host#3, the VM host#2 measures the transfer rate between the VM host#2 and the VM host#4, and the VM host#3 measures the transfer rate between the VM host#3 and the VM host#5. In addition, the VM host#4 measures the transfer rate between the VM host#4 and the VM host#1, and the VM host#5 measures the transfer rate between the VM host#5 and the VM host#2.

In other words, the VM host#j measures the transfer rate in the direction to the VM host#j+2, the VM host#m−1 measures the transfer rate in the direction to the VM host#1, and the VM host#m measure the transfer rate in the direction to the VM host#2. Where, j is an integer of 1 or more and m−2 or less.

When the transfer rate measurement process illustrated in (1) of FIG. 20 is completed, a transfer rate table 5 illustrated in (2) of FIG. 20 is obtained. In the transfer rate table 5 illustrated in (2) of FIG. 20, five transfer rates 6 to 10 measured by the transfer rate measurement process illustrated in (1) of FIG. 20 are newly registered.

The transfer rate in one directional communication through the bidirectional communication paths between the VM hosts 2 is registered in the transfer rate table 5 illustrated in (2) of FIG. 20. That is, the transfer rate in the direction from the VM host#c to the VM host#d or the transfer rate in the direction from the VM host#d to the VM host#c is registered in the transfer rate table 5 illustrated in (2) of FIG. 20. Where, c and d are different integers of 1 or more and m or less.

When the transfer rate in one directional communication through the bidirectional communication paths between the VM hosts 2 is registered in the transfer rate table 5, the transfer rate between all the VM hosts 2 may be known.

### [B-2] Operation Example

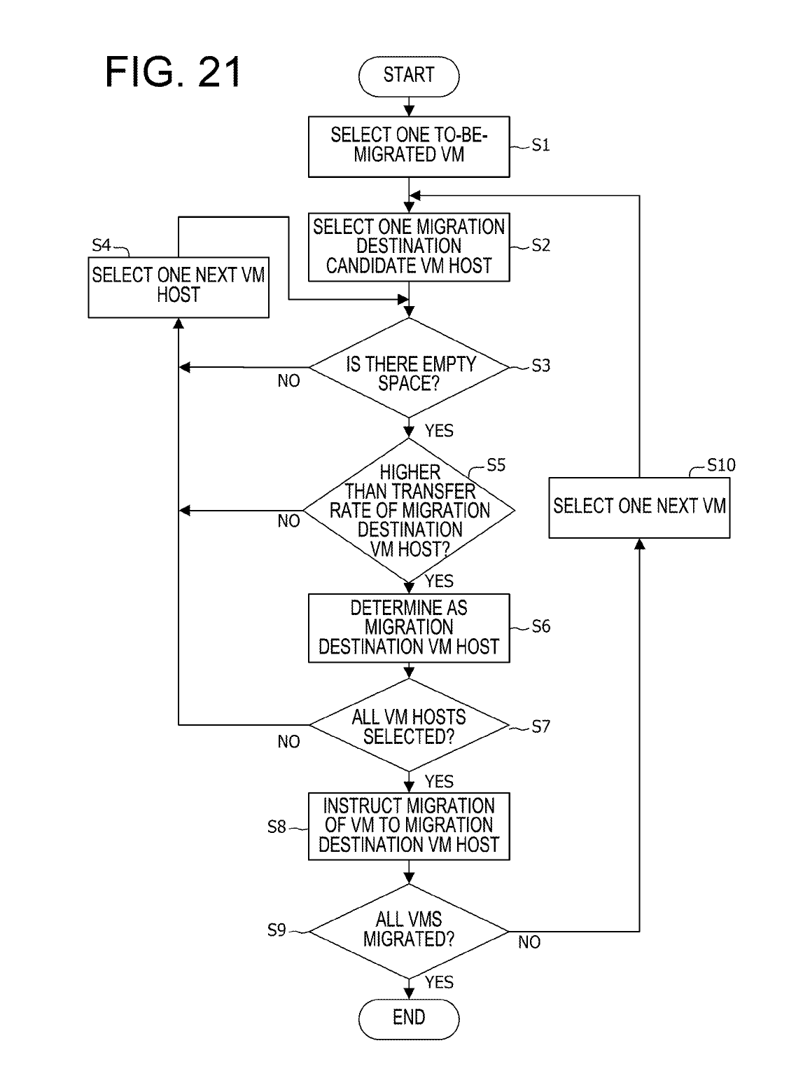

An example of the VM migration process illustrated in FIGS. 11 to 14 will be described according to a flowchart illustrated in FIG. 21 (steps S1 to S10).

The determination unit 112 of the management server 1 selects one to-be-migrated VM 3 in order of priority (step S1).

The determination unit 112 selects one VM host 2 out of plural migration destination candidate VM hosts 2 (step S2).

The determination unit 112 determines whether there is an empty space in the selected VM host 2 (step S3).

When there is no empty space (“No” in step S3), the determination unit 112 selects one VM host 2 next among the plural migration destination candidate VM hosts 2 (step S4). Then, the process returns to the step S3.

In the meantime, when there is an empty space (“Yes” in step S3), the determination unit 112 determines whether the transfer rate of the currently selected VM host 2 is higher than the transfer rate of the migration destination VM host 2 (step S5). The determination unit 112 may perform the determination of step S5 based on the transfer rate between VM hosts 2 measured by the measurement unit 211 of each VM host 2 in real time and acquired by the acquisition unit 111 of the management server 1.

When the transfer rate of the currently selected VM host 2 is not higher than the transfer rate of the migration destination VM host 2 (“No” in step S5), the process proceeds to the step S4.

In the meantime, when the transfer rate of the currently selected VM host 2 is higher than the transfer rate of the migration destination VM host 2 (“Yes” in step S5), the determination unit 112 determines the currently selected VM host 2 as the migration destination VM host 2 (step S6). When the migration destination VM host 2 has not been determined at the step S5, the determination at the step S5 is not made and the VM host 2 being selected at the step S6 is determined as the migration destination VM host 2.

The determination unit 112 determines whether all the VM hosts 2 have been selected (step S7).

When all the VM hosts 2 have not been selected (“No” in step S7), the process proceeds to the step S4.

In the meantime, when all the VM hosts 2 have been selected (“Yes” in step S7), the determination unit 112 instructs the migration destination VM host 2 to migrate the to-be-migrated VM 3 (step S8).

The determination unit 112 determines whether all the to-be-migrated VMs 3 have been migrated (step S9).

When all the to-be-migrated VMs 3 have not been migrated (“No” in step S9), the determination unit 112 selects next one to-be-migrated VM 3 in order of priority (step S10). Then, the process returns to the step S2.

In the meantime, when all the to-be-migrated VMs 3 have been migrated (“Yes” in step S9), the process is ended.

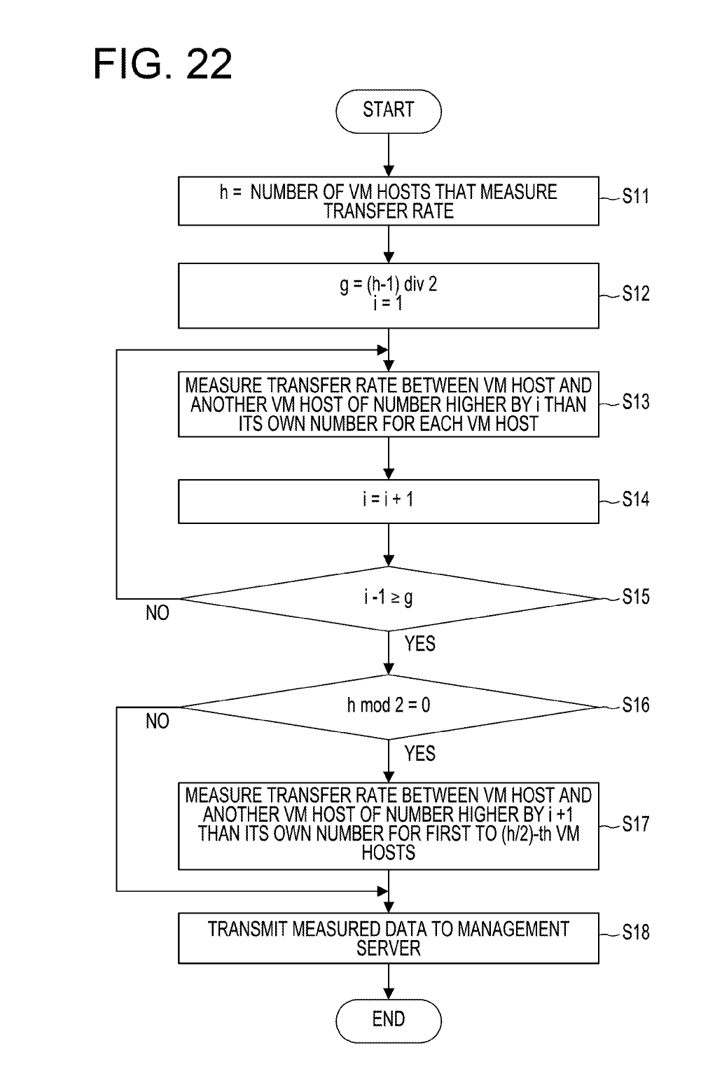

Next, an example of the transfer rate measurement process illustrated in FIGS. 15 to 20 will be described with reference to a flow chart illustrated in FIG. 22 (steps S11 to S18).

The measurement unit 211 of each VM host 2 acquires the number h of VM hosts 2 that measures a transfer rate (step S11).

The measurement unit 211 of each VM host 2 calculates g=(h−1)div 2 (i.e., calculates a value obtained by dividing h−1 by 2, as g) and sets i to 1 (step S12).

The measurement unit 211 of each VM host 2 measures the transfer rate between the VM host 2 and another VM host 2 of a number higher by i than its own number (step S13).

The measurement unit 211 of each VM host 2 sets i to i+1 (step S14).

The measurement unit 211 of each VM host 2 determines whether i−1 is equal to or greater than g (step S15).

When i−1 is less than g (“No” in step S15), the process returns to the step S13.

In the meantime, when i−1 is equal to or greater than g (“Yes” in step S13), the measurement unit 211 of each VM host 2 determines whether h mod 2 is equal to 0 (i.e., h is an even number) (step S16).

When h mod 2 is not equal to 0 (“No” in step S16), the process proceeds to step S18.

In the meantime, when h mod 2 is equal to 0 (“Yes” in step S16), the measurement unit 211 of each of the VM host#1 to the VM host#h/2 measures the transfer rate between itself and the VM host 2 of a number higher by i+1 than its own number (step S17).

The notification unit 212 of each VM host 2 transmits the measured data to the management server 1 (step S18). Then, the process is ended.

### [B-3] Effects

According to the information processing system 100 in the above-described example of the embodiment, for example, the following effects may be obtained.

The acquisition unit 111 acquires the data transfer rate between the migration source VM host 2 and the plural migration destination VM hosts 2. In addition, based on the transfer rates acquired by the acquisition unit 111, the determination unit 112 decides the VM host 2 as the migration destination of each VM 3 among the plural migration destination candidate VM hosts in order of priority set for each of the plural VMs 3.

As a result, the migration between the VM hosts 2 may be completed in order from the VM 3 with the highest priority.

The acquisition unit 111 acquires the transfer rate in the direction from the VM host#1 to the VM host#2, but does not acquire the transfer rate in the direction from the VM host#2 to the VM host#1.

As a result, the number of transfer rates to be measured and acquired may be halved, and the load related to the measurement and acquisition of the transfer rate may be reduced.

Assume that n is an even number of 4 or more, k is an integer of 1 to n, and i is an integer of 1 to n/2−1. The acquisition unit 111 acquires the transfer rate in the direction from the VM host#k to the VM host#k+i. When k+i exceeds n, k+i is replaced with k+i−n. Further, the acquisition unit 111 acquires the transfer rate in the direction from the VM host#l to the VM host#l+n/2 for an integer l of 1 to n/2. When l+n/2 exceeds n, l+n/2 is replaced with l+n/2−n.

As a result, when the number of VM hosts 2 deployed in the information processing system 100 is an even number, it is possible to efficiently measure and acquire the transfer rate between the VM hosts 2.

Also assume that m is an odd number of 3 or more, k is an integer of 1 to m, and j is an integer of 1 to (m−1)/2. The acquisition unit 111 acquires the transfer rate in the direction from the VM host#k to the VM host#k+j. When k+j exceeds m, k+j is replaced with k+j−m.

As a result, when the number of VM hosts 2 deployed in the information processing system 100 is an odd number, it is possible to efficiently measure and acquire the transfer rate between the VM hosts 2.

### [C] Modified Examples

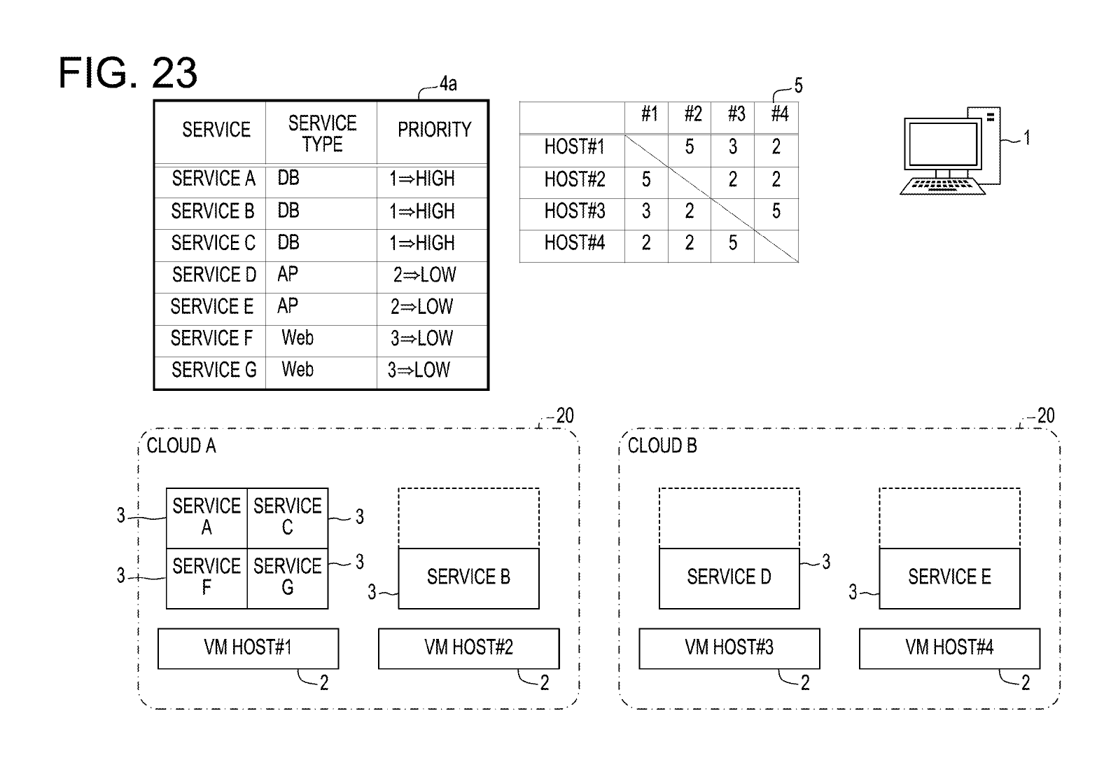

FIGS. 23 to 28 are views for explaining an example of the VM migration process in the information processing system 100, as modified examples of the embodiments.

In the examples illustrated in FIGS. 23 to 28, the data volumes of services A, C, F, and G are the same, and the data volumes of services B, D, and E are the same. Further, the data volumes of the services A, C, F, and G are smaller than the data volumes of the services B, D, and E. The data capacities of the VM hosts 2 are the same.

In the example illustrated in FIGS. 23 to 28, the management server 1 executes the VM migration process based on a priority table 4a. Similarly to the priority table 4 illustrated in FIGS. 11 to 14, the priority table 4a represents the priority of restoration of each service 3 in a case where a failure occurs in the VM hosts 2 on which the services 3 are installed. A lower priority indicates a higher order of restoration of services 3. In the examples illustrated in FIGS. 23 to 28, one of the priorities “1” to “3” is associated with the services A to G.

In comparison with the priority table 4 illustrated in FIGS. 11 to 14, the priority table 4a illustrated in FIGS. 23 to 28 is added with “service type”. “Service type” indicates “DB”, “AP”, and “Web” of each service 3, separately. “DB” indicates a database server, “AP” indicates an application server, and “Web” indicates a web server.

Unless the database server is restored, other services 3 such as the application servers and the web server will not be restored. Therefore, in the priority table 4a, the priority of the database server set to priority “1” is changed to “high”, and the priorities of the application server and the web server set to priorities “2” and “3”, respectively, are changed to “low”.

In other words, the priority is classified into a first group and a second group having a lower priority than the first group.

In the example illustrated in FIG. 23, the services A, C, F, and G are deployed in the VM host#1, and the service B is deployed in the VM host#2. In addition, the service D is deployed in the VM host#3, and the service E is deployed in the VM host#4.

The VM hosts 2 are deployed in a cloud 20 (which may be referred to as a “cloud A or B”). In the example illustrated in FIG. 23, the VM host#1 and the VM host#2 are deployed in the cloud A, and the VM host#3 and the VM host#4 are deployed in the cloud B.

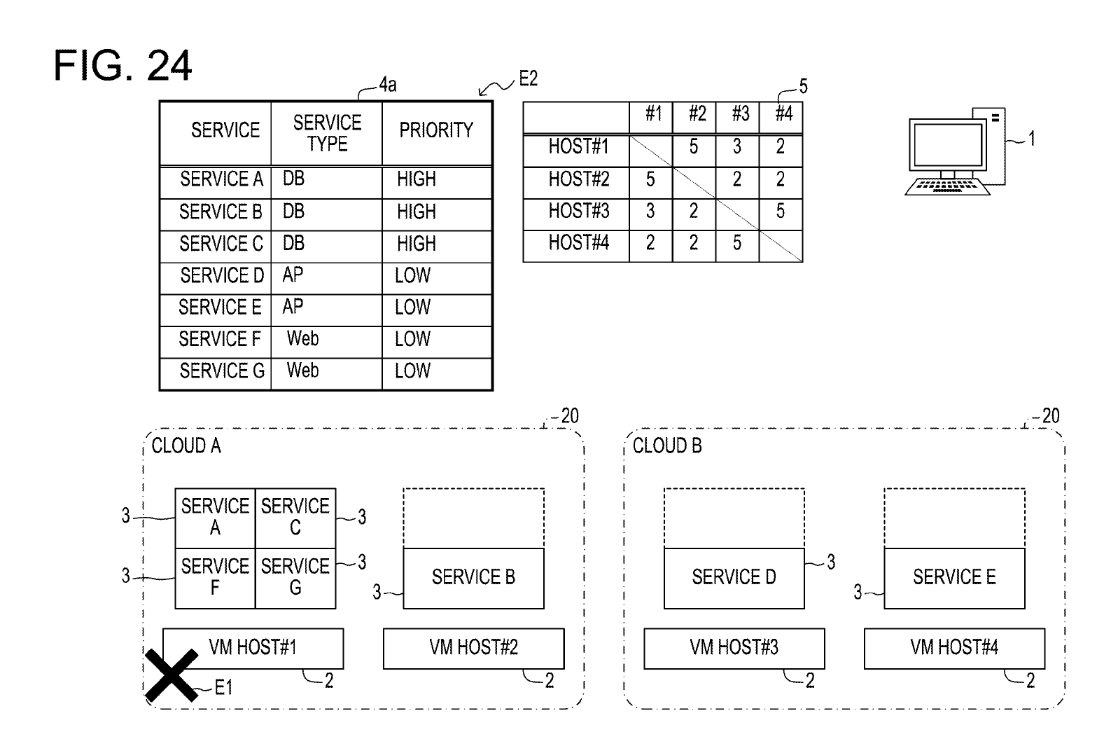

Here, it is assumed that an abnormality such as a failure has occurred in the VM host#1 (see reference symbol E1 in FIG. 24).

From the priority table 4a, the determination unit 112 of the management server 1 refers to the priorities of the services A, C, F, and G deployed in the VM host#1 in which an abnormality has occurred (see reference symbol E2 in FIG. 24). In this example, the priorities of the services A and C are relatively high and the priorities of the services F and G are relatively low. That is, the priorities of the services A and C are higher than the priorities of the services F and G.

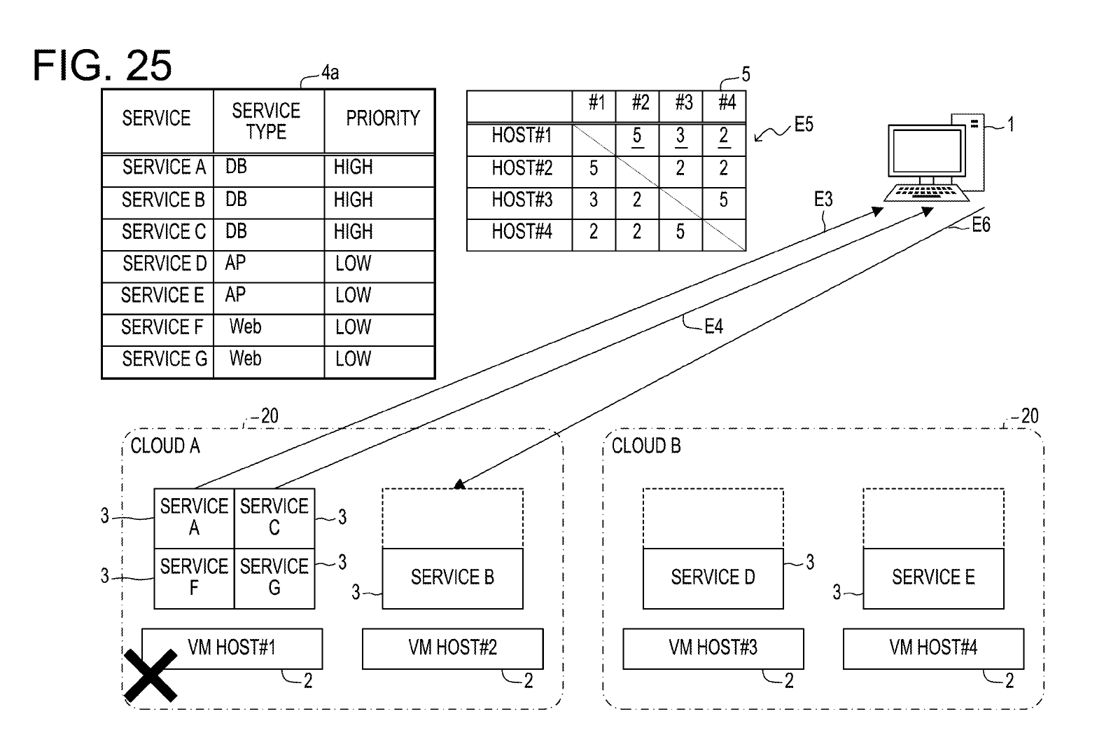

First, the determination unit 112 determines to migrate the services A and C having the highest priority in the VM host#1 in which the abnormality has occurred (see reference symbols E3 and E4 in FIG. 25).

The determination unit 112 refers to the transfer rate table 5 (see reference symbol E5 in FIG. 25) to determine the VM host#2 having the largest transfer rate of 5 GB/s from the VM host#1 among the VM hosts 2 to which the services A and C may be migrated, as the migration destinations of the services A and C (see reference symbol E6 in FIG. 25).

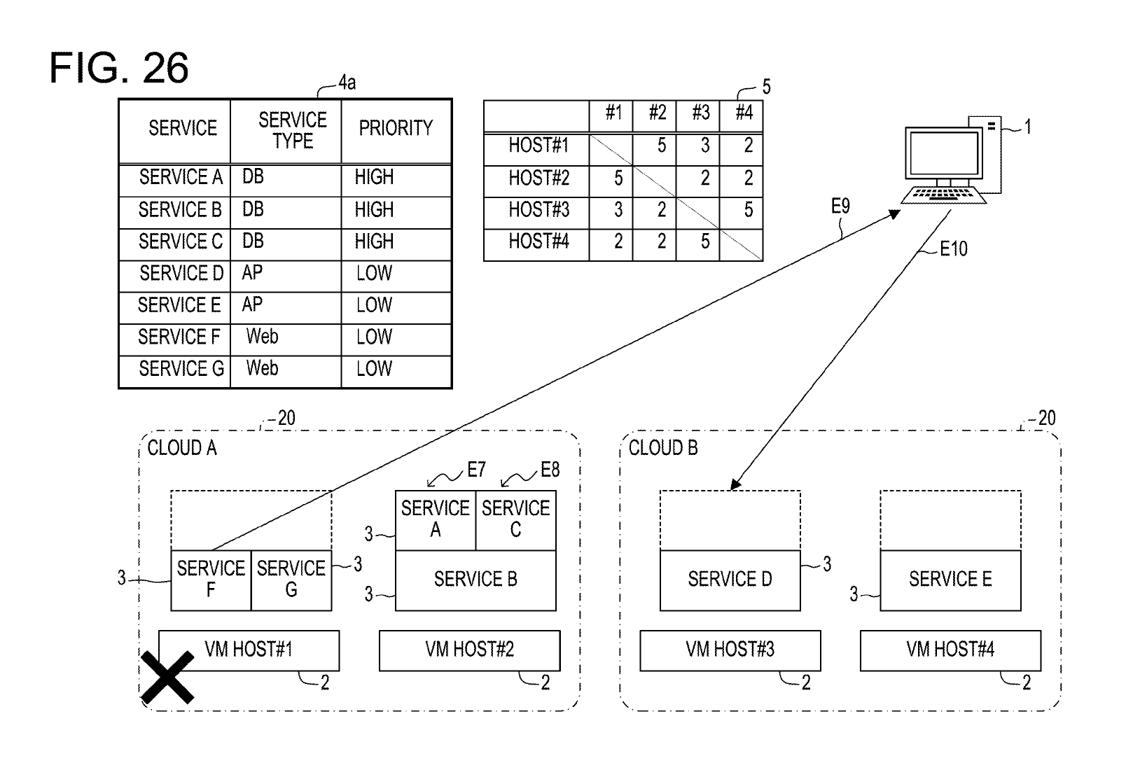

Then, the services A and C are deployed in the migration destination VM host#2 (see reference symbols E7 and E8 in FIG. 26).

Next, the determination unit 112 of the management server 1 determines to migrate the service F having the lowest priority in the VM host#1 in which the abnormality has occurred (see reference symbol E9 in FIG. 26).

The determination unit 112 determines the VM host#3 having the largest empty space among the VM hosts 2 to which the service F may be migrated after the services A and C are migrated, as the migration destination of the service F (see reference symbol E10 in FIG. 26). Since the empty space of the VM host#3 and the empty space of the VM host#4 are the same after the services A and C are migrated, in this example, the service F is migrated to the VM host#3 having a smaller number of the VM hosts 2.

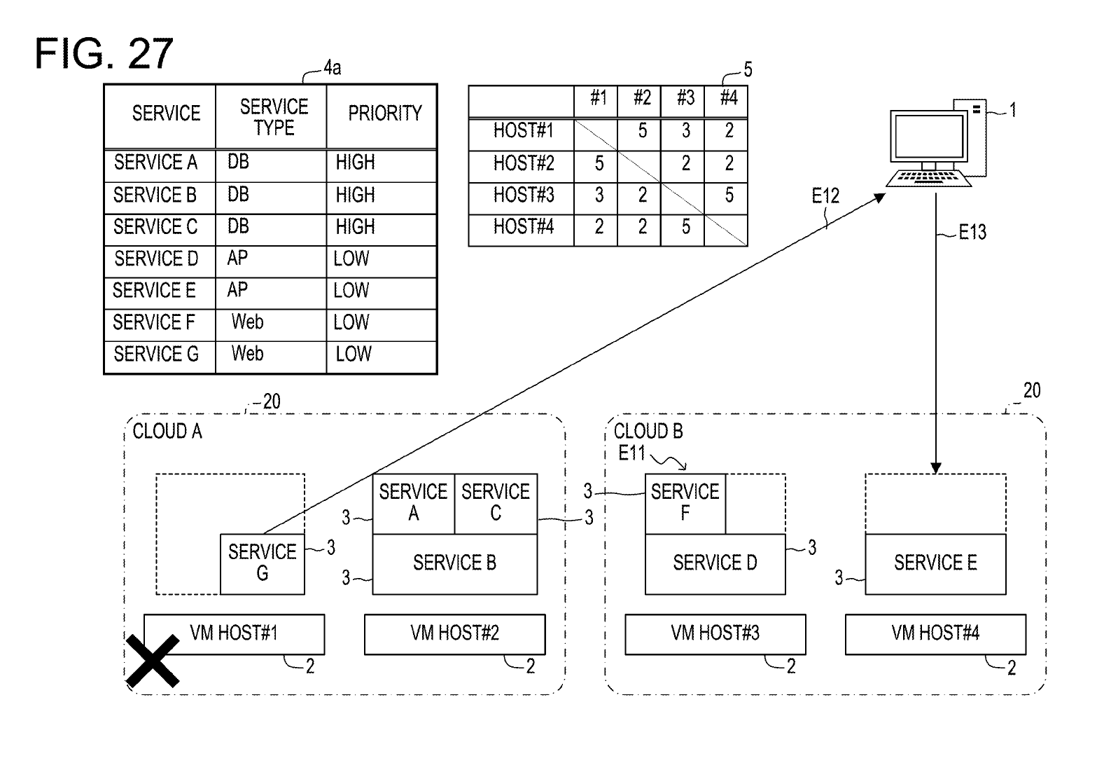

Then, the service F is deployed in the migration destination VM Host#3 (see reference symbol E11 in FIG. 27).

Next, the determination unit 112 of the management server 1 determines to migrate the service G having the low priority in the VM host#1 in which the abnormality has occurred (see reference symbol E12 in FIG. 27).

The determination unit 112 determines the VM host#4 having the largest empty space among the VM hosts 2 to which the service G may be migrated after the services A, C and F are migrated, as the migration destination of the service G (see reference symbol E13 in FIG. 27).

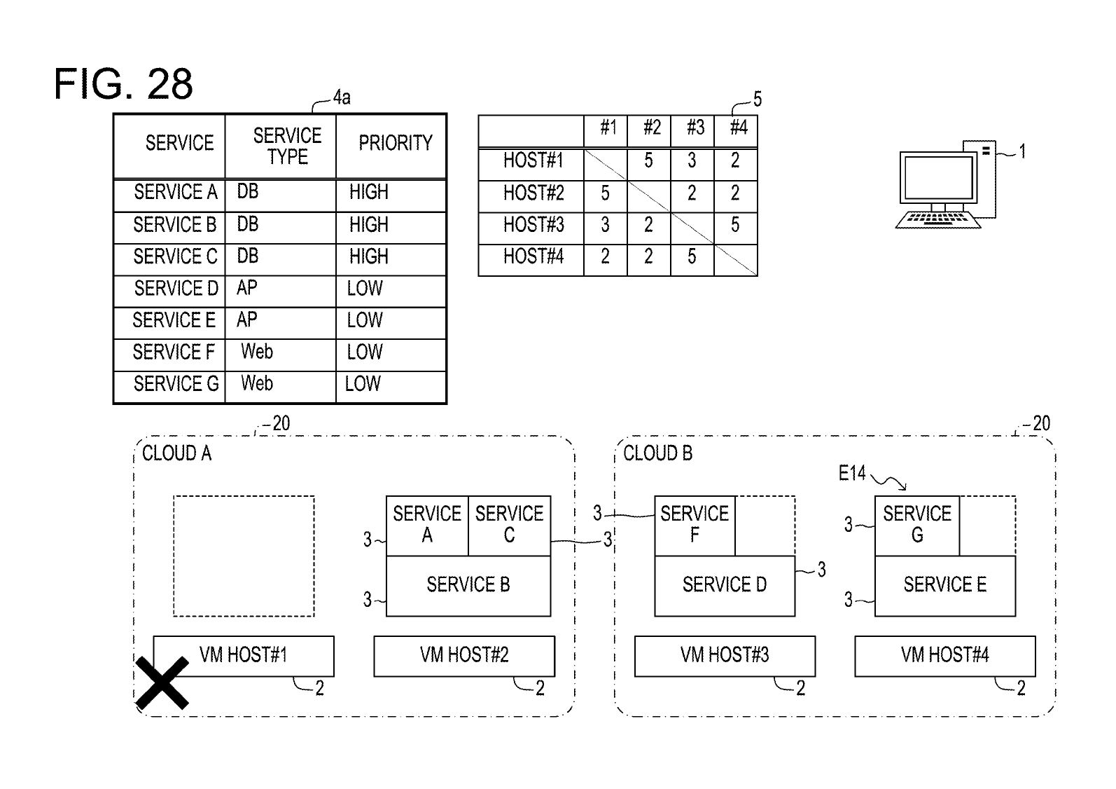

Then, the service G is deployed in the migration destination VM host#4 (see reference symbol E14 in FIG. 28).

That is, for the VM 3 classified as the first group having a higher priority, the determination unit 112 determines the migration destination VM host 2 based on a transfer rate. For the VM 3 classified as the second group having a relatively lower priority, the determination unit 112 determines the migration destination VM host 2 based on the load distribution condition of plural migration destination candidate VM hosts 2.

As a result, in the information processing system 100 according to the modification of the embodiment, similarly to the information processing system 100 in the example of the embodiment, it is possible to start and complete the migration process between the VM hosts 2 of the VMs 3 with a relatively high restoration priority at an early stage. Further, in the information processing system 100 according to the modification of the embodiment, it is possible to execute the VM migration process in consideration of both the restoration priority of the VM 3 and the load distribution between the VM hosts 2.

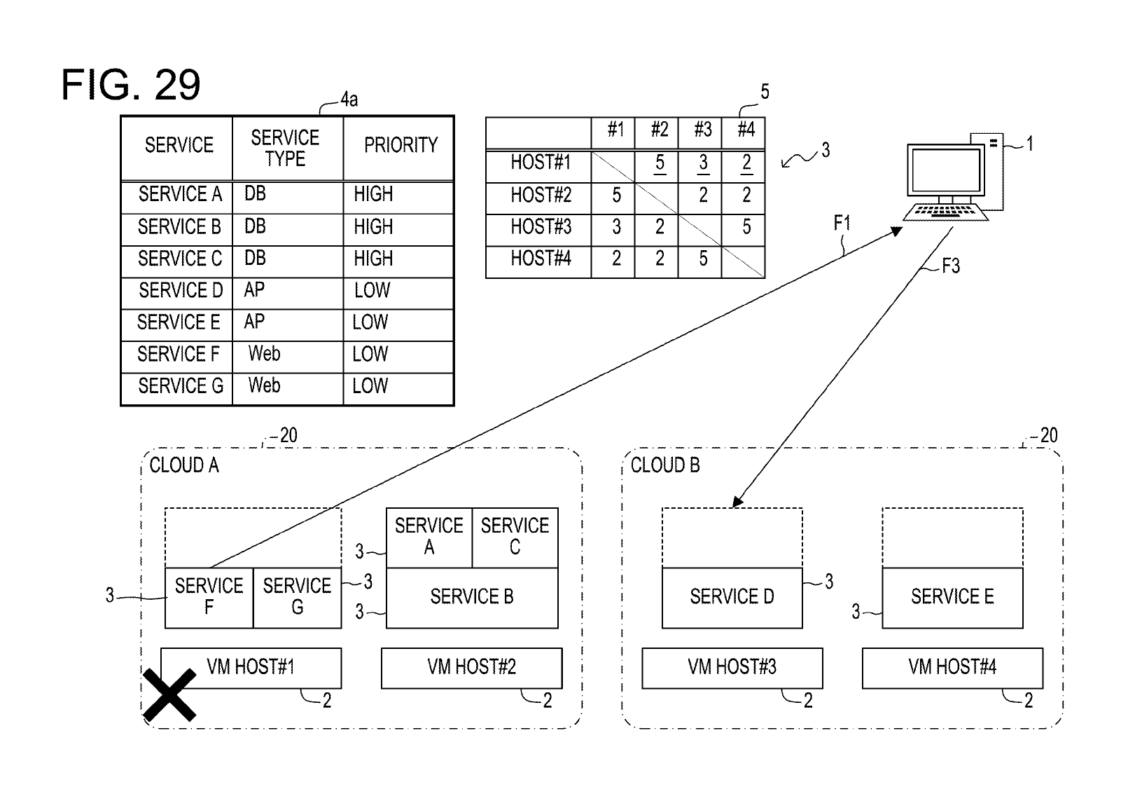

FIGS. 29 to 31 are views for explaining an example of the VM migration process in the information processing system 100, as a related example. In this related example, descriptions will be given of a case where the migration destination VM host 2 is determined based on a transfer rate for the services 3 with a relatively low priority.

FIG. 29 illustrates the same state as in FIG. 26 described above. That is, the determination unit 112 of the management server 1 determines to migrate the service F with the low priority in the VM host#1 in which the abnormality has occurred (see reference symbol F1 in FIG. 29).

The determination unit 112 refers to a transfer rate table 5 (see reference symbol F2 in FIG. 29). Then, the determination unit 112 determines the VM host#3 having the largest transfer rate of 3 GB/s among the VM hosts 2 to which the service F may be migrated after the services A and C are migrated, as the migration destination of the service F (see reference symbol F3 in FIG. 29). After the services A and C are migrated, since the VM host#2 having the transfer rate of 5 GB/s has no empty space, the service F is unable to be migrated.

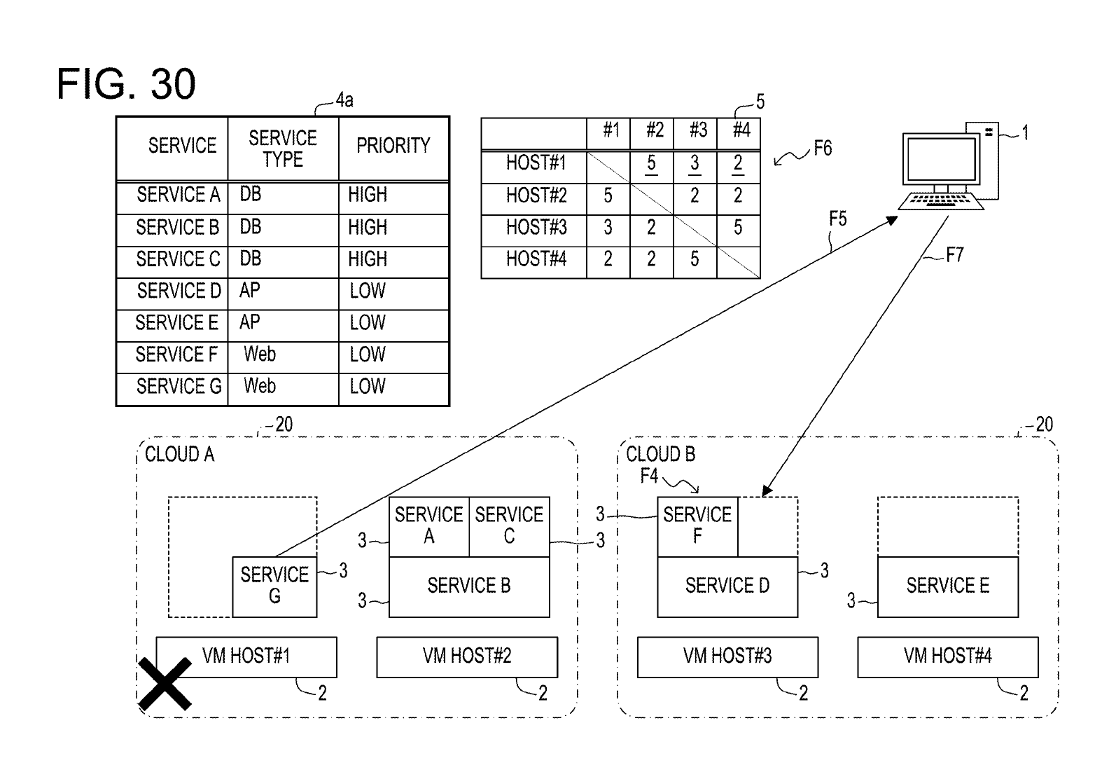

Then, the service F is deployed in the migration destination VM host#3 (see reference symbol F4 in FIG. 30).

Next, the determination unit 112 of the management server 1 determines to migrate the service G with the low priority in the VM host#1 in which the abnormality has occurred (see reference symbol F5 in FIG. 30).

The determination unit 112 refers to a transfer rate table 5 (see reference symbol F6 in FIG. 30). Then, the determination unit 112 determines the VM host#3 having the largest transfer rate of 3 GB/s among the VM hosts 2 to which the service G may be migrated after the services A, C and F are migrated, as the migration destination of the service G (see reference symbol F7 in FIG. 30). After the services A, C and F are migrated, since the VM host#2 having the transfer rate of 5 GB/s has no empty space, the service G is unable to be migrated.

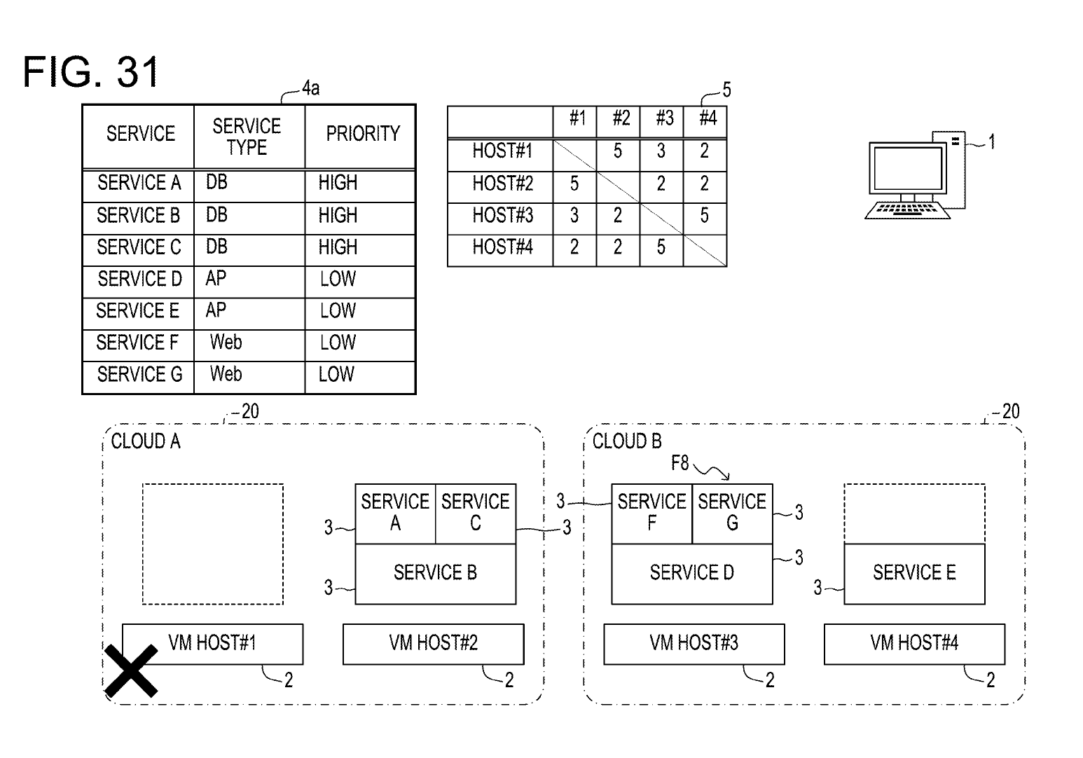

Then, the service G is deployed in the migration destination VM host#3 (see reference symbol F8 in FIG. 31).

In this way, in the information processing system 100 as a related example illustrated in FIGS. 29 to 31, the load is not distributed in the VM host#3.

### [D] Others

The disclosed technology is not limited to the above-described embodiment, but various modifications may be made and practiced without departing from the spirit and scope of the present disclosure. Each configuration and each process of the present embodiment may be selected as required or may be combined as appropriate.

In the above-described modification of the embodiment, in the priority table 4a illustrated in FIG. 23, the priority “1” is changed to the priority “high”, and the priorities “2” and “3” are changed to the priority “low”. However, the present disclosure is not limited thereto. For example, the priorities “1” and “2” may be changed to the priority “high” and the priority “3” may be changed to the priority “low”. As another example, when the priorities “1” to “4” are set in the priority table 4a, the priorities “1” to “3” may be changed to the priority “high” and the priority “4” may be changed to the priority “low”.

In the above-described example and modification of the embodiment, the migration destination VM host 2 for the plural VMs 3 is determined based on the data transfer rate between the VM hosts 2. However, the present disclosure is not limited thereto. For example, the migration destination VM host 2 for one VM 3 may be determined based on the data transfer rate between the VM hosts 2. As a result, it is possible to complete restoration of one to-be-migrated VM 3 at an early stage.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
acquire a data transfer rate between a source device and each of destination candidate devices, the information processing apparatus being communicably coupled to the source device and to the destination candidate devices, the source device serving as a migration source from which virtual machines are migrated, the destination candidate devices being candidates of a destination device serving as a migration destination to which each of the virtual machines is migrated; and
determine, based on the acquired data transfer rate, the destination device for each of the virtual machines among the destination candidate devices in an order of priority set for each of the virtual machines.

2. The information processing apparatus according to claim 1, wherein
the priority set for each of the virtual machines is included in a first priority group or a second priority group including priorities lower than priorities included in the first priority group, and
the processor is further configured to:
determine the destination device based on the transfer rate for virtual machines set with a priority included in the first priority group; and
determine the destination device based on a condition of loads distributed to the destination candidate devices for virtual machines set with a priority included in the second priority group.

3. The information processing apparatus according to claim 1, wherein
the processor is further configured to acquire the transfer rate between a first device and a second device in a direction from the first device to the second device and not to acquire the transfer rate in a direction from the second device to the first device, the first and second devices being included in a group of the source device and the destination candidate devices.

4. The information processing apparatus according to claim 3, wherein
a group of the source device and the destination candidate devices includes first to n-th devices wherein n is an even number of 4 or more, and
the processor is further configured to:
acquire the transfer rate in a direction from a k-th device to a (k+i)-th device wherein k+i is replaced with k+i−n when k+i exceeds n, k being an integer of 1 to n, i being an integer of 1 to n/2−1; and
acquire the transfer rate in a direction from an l-th device to an (l+n/2)-th device wherein l+n/2 is replaced with l+n/2-n when l+n/2 exceeds n, l being an integer of 1 to n/2.

5. The information processing apparatus according to claim 3, wherein
a group of the source device and the destination candidate devices includes first to m-th devices wherein m is an odd number of 3 or more, and
the processor is further configured to:
acquire the transfer rate in a direction from a k-th device to a (k+j)-th device wherein k+j is replaced with k+j−m when k+j exceeds m, k being an integer of 1 to m, j being an integer of 1 to (m−1)/2.

6. An information processing system comprising:
host devices each including:
a first memory; and
a first processor coupled to the first memory and the first processor configured to a migrate a virtual machine to any of the host devices; and
an information processing apparatus configured to be communicably coupled to the host devices, the information processing apparatus comprising:
a second memory; and
a second processor coupled to the second memory and the second processor configured to:
acquire a data transfer rate between a source device and each of destination candidate devices, the source device being one of the host devices and the destination candidate devices being the others of the host devices, the source device serving as a migration source from which virtual machines are migrated, the destination candidate devices being candidates of a destination device serving as a migration destination to which each of the virtual machines is migrated; and
determine, based on the acquired data transfer rate, the destination device for each of the virtual machines among the destination candidate devices in an order of priority set for each of the virtual machines.

7. The information processing system according to claim 6, wherein
the priority set for each of the virtual machines is included in a first priority group or a second priority group, the second priority group including priorities lower than priorities included in the first priority group, and
the second processor is further configured to:
determine the destination device based on the transfer rate for virtual machines set with a priority included in the first priority group; and
determine the destination device based on a condition of loads distributed to the destination candidate devices for virtual machines set with a priority included in the second priority group.

8. The information processing system according to claim 7, wherein
the second processor is further configured to acquire the transfer rate between a first device and a second device in a direction from the first device to the second device and not to acquire the transfer rate in a direction from the second device to the first device, the first and second devices each being one of the host devices.

9. The information processing system according to claim 8, wherein
the host devices are first to n-th devices wherein n is an even number of 4 or more, and
the second processor is further configured to:
acquire the transfer rate in a direction from a k-th device to a (k+i)-th device wherein k+i is replaced with k+i−n when k+i exceeds n, k being an integer of 1 to n, i being an integer of 1 to n/2−1; and
acquire the transfer rate in a direction from an l-th device to an (l+n/2)-th device wherein l+n/2 is replaced with l+n/2−n when l+n/2 exceeds n, l being an integer of 1 to n/2.

10. The information processing system according to claim 8, wherein the host devices are first to m-th devices wherein m is an odd number of 3 or more, and
the second processor is further configured to:
acquire the transfer rate in a direction from a k-th device to a (k+j)-th device wherein k+j is replaced with k+j−m when k+j exceeds m, k being an integer of 1 to m, j being an integer of 1 to (m−1)/2.

11. A non-transitory computer-readable recording medium having stored therein a program that causes a computer to execute a process, the process comprising:
acquiring a data transfer rate between a source device and each of destination candidate devices, the computer being communicably coupled to the source device and to the destination candidate devices, the source device serving as a migration source from which virtual machines are migrated, the destination candidate devices being candidates of a destination device serving as a migration destination to which each of the virtual machines is migrated; and
determining, based on the acquired data transfer rate, the destination device for each of the virtual machines among the destination candidate devices in an order of priority set for each of the virtual machines.

12. The non-transitory computer-readable recording medium according to claim 11, wherein
the priority set for each of the virtual machines is included in a first priority group or a second priority group including priorities lower than priorities included in the first priority group, and
the process further comprises:
determining the destination device based on the transfer rate for virtual machines set with a priority included in the first priority group; and
determining the destination device based on a condition of loads distributed to the destination candidate devices for virtual machines set with a priority included in the second priority group.

13. The non-transitory computer-readable recording medium according to claim 11, the process further comprising:
acquiring the transfer rate between a first device and a second device in a direction from the first device to the second device and not to acquire the transfer rate in a direction from the second device to the first device, the first and second devices being included in a group of the source device and the destination candidate devices.

14. The non-transitory computer-readable recording medium according to claim 13, wherein
a group of the source device and the destination candidate devices includes first to n-th devices wherein n is an even number of 4 or more, and
the process further comprises:
acquiring the transfer rate in a direction from a k-th device to a (k+i)-th device wherein k+i is replaced with k+i−n when k+i exceeds n, k being an integer of 1 to n, i being an integer of 1 to n/2−1; and
acquiring the transfer rate in a direction from an l-th device to an (l+n/2)-th device wherein l+n/2 is replaced with l+n/2−n when l+n/2 exceeds n, l being an integer of 1 to n/2.

15. The non-transitory computer-readable recording medium according to claim 13, wherein
a group of the source device and the destination candidate devices includes first to m-th devices wherein m is an odd number of 3 or more, and
the process further comprises:
acquiring the transfer rate in a direction from a k-th device to a (k+j)-th device wherein k+j is replaced with k+j−m when k+j exceeds m, k being an integer of 1 to m, j being an integer of 1 to (m−1)/2.
